(19) United States
(12) Patent Application Publication
(10) Pub. No.: US 2025/0381555 A1
(43) Pub. Date: Dec. 18, 2025

(54) INTERMEDIATE ARTICLES HAVING CATALYTIC INK

(71) Applicant: Eastman Kodak Company, Rochester, NY (US)

(72) Inventors: Christine J. T. Coltrain, Fairport, NY (US); John Joseph Scheible, Fairport, NY (US); Joseph Salvalore Sedita, Albion, NY (US)

(21) Appl. No.: 18/743,259

(22) Filed: Jun. 14, 2024

(51) Int. Cl. B01J 23/50; A01N 25/10; A01N 25/34; A01N 59/16; A01P 1/00; B01J 21/08; B01J 31/06; B01J 35/45; B01J 35/55; B01J 35/58

(52) U.S. Cl. CPC B01J 23/50; A01N 25/10; A01N 25/34; A01N 59/16; A01P 1/00; B01J 21/08; B01J 31/06; B01J 35/45; B01J 35/55; B01J 35/58

(57) ABSTRACT

An intermediate article has a non-electrically conductive substrate having first and second opposing surfaces; and a catalytic ink disposed as a pattern of half-tone dots on at least the first opposing surface. Copper metal can be plated on the pattern of catalytic ink to provide a copper metal pattern that have antimicrobial properties. The resulting antimicrobial article can then be applied to various surfaces to mitigate the spread of infectious agents from one person to another.

### CROSS-REFERENCE TO RELATED APPLICATIONS

Reference is also made to the following related copending and commonly assigned patent application:
U.S. Ser. No. ______ filed on even date herewith by Scheible, Coltrain, and Sedita, and entitled “Antimicrobial Articles” (Attorney Docket K004014);
U.S. Ser. No. ______ filed on even date herewith by Coltrain, Scheible, and Sedita, and entitled “Antimicrobial Articles Having Peelable Liners and Manufacturing Methods” (Attorney Docket K004022);
U.S. Ser. No. ______ filed on even date herewith. by Coltrain, Scheible, and Sedita, and entitled “Method for Preparing Non-electrically Conductive Antimicrobial Articles” (Attorney Docket K004017);
U.S. Ser. No. ______ filed on even date herewith. by Scheible, Coltrain, and Sedita, and entitled “Method for Mitigating Microbial Activity Using Antimicrobial Articles” (Attorney Docket K004018); and
U.S. Ser. No. ______ filed on even date herewith by Scheible, Coltrain, and Sedita, and entitled “Articles Protected with Antimicrobial Articles Attached Thereto” (Attorney Docket K004023.

### FIELD OF THE INVENTION

This invention relates to what is considered intermediate articles having a non-electrically conductive substrate on which a pattern of a catalytic ink is disposed. This catalytic ink pattern comprises a multiplicity of half-tone dots. The intermediate articles can be used for further processing or manufacturing, including the preparation of antimicrobial articles described herein that are effective for mitigating the viability and transmission of various infectious agents such as microorganisms and viruses.

### BACKGROUND OF THE INVENTION

Widespread attention has been focused in recent years on the consequences of bacterial, viral, and fungal contamination and transmission from human contact with common surfaces and objects. Both mild and acute illnesses are often associated with human contact with bacteria such as Staphylococcus aureus, Pseudomonas aeruginosa, Escherichia coli, as well as other infectious agents such as viruses that are associated with the common cold, influenza, pneumonia, COVID-19, and other respiratory illnesses. Some noteworthy examples of these ill effects include the sometimes fatal outcome from food poisoning due to the presence of particular strains of Escherichia coli in undercooked beef; Salmonella contamination in undercooked and unwashed poultry food products; and illnesses and skin irritations due to Staphylococcus aureus and other micro-organisms. While some of these illnesses occur in food products, the unwashed hands of food handlers can transmit such microorganisms to commonly touched surfaces.

Anthrax is an acute infectious disease caused by the spore-forming bacterium Bacillus anthracis. Allergic reactions to molds and yeasts are a major concern to many consumers and insurance companies alike. In addition, significant fear has arisen in regard to the development of antibiotic-resistant strains of bacteria, such as methicillin-resistant Staphylococcus aureus (MRSA), Pseudomonas aeruginosa, and vancomycin-resistant Enterococcus (VRE). The Centers for Disease Control and Prevention estimates that 10% of patients contract additional diseases during a hospital stay and that the total deaths resulting from these nosocomial illnesses exceeds those suffered from vehicular traffic accidents and homicides. All of these microorganisms can be inadvertently placed on surfaces that are commonly touched and thereby transmitted well beyond the original carrier. In response to these concerns, manufacturers have begun incorporating antimicrobial agents into materials used to produce objects for commercial, institutional, personal, and residential use and to place such antimicrobial agents on surfaces when feasible, as described below.

Thus, while much infection can be transmitted through the air or by ingestion of food and fluids such as water, many troublesome organisms can be passed on by contact with fomites. Fomites are defined as inanimate surfaces that when contaminated with an infectious agent (such as pathogenic bacteria, viruses, or fungi) can facilitate their transmission from touching by multiple individuals while the infectious agent is still viable. Examples of fomites include but are not limited to, textiles, countertops, door handles, light switches, mobile phones, vehicle inside surfaces, furniture, public or private facility handrails and bed rails, bathroom hardware, grab rails, touch screens in various electronic devices such as personal computers, ATM's, and cell phones, and other surfaces commonly encountered in medical and dental facilities, child and elder care facilities, schools, and food processing facilities such as kitchens and restaurants. Transmission to a human may occur from fingers and hands to eyes, mouth, or nose after contact with fomites. In the past, cleanliness and sanitation of such facilities and objects required frequent and time-consuming cleaning methods including wiping with antimicrobial or anti-viral agents, disinfecting wipes, and other cleaning agents that have been developed for professional and home use. However, many chemical compositions having antimicrobial agents (that is, disinfectants) can be harmful to both the environment and the user, and they may lose their effectiveness within a short period of time. Moreover, because the interfaces of electronic devices such as keyboards, keypads, touch panels, touch screens, and cell phone screens may be touched by numerous people in a short period of time, cleanliness regimens may be ineffective and onerous, and may not be possible with liquid cleansers. As various cleaning industries realize, it is almost impossible to personally clean every suspect surface frequently enough to inhibit transmission of harmful microorganisms.

Many historical publications teach that copper, copper alloys, and copper nanoparticles are known to provide antimicrobial activity. Copper and its alloys (such as brasses, bronzes, cupronickel, copper-nickel-zinc, silver-copper-zinc, and copper-tin alloys) are natural antimicrobial agents. Ancient civilizations exploited the antimicrobial properties of copper long before the concept of microbes and their dangers became known during the nineteenth century. More recently, the U.S. Environmental Protection Agency (EPA) has approved the registration of over 500 copper metal and copper-containing compositions as “antimicrobial public health materials” [see https://copperalloystewardship.com and also as reported in U.S. Patent Application Publication 2017/0183545A1 (Kelleher)], and as useful for lowering the risk of transmission of pathogens from fomites. Manufacturers of such antimicrobial agents may make provable Public Health Claims (PHC) that are specific quantitative statements of antimicrobial efficacy after the extensive testing required by the EPA with a rigorous microbiological protocol.

In addition, copper ions and noble metal ions such as silver and gold ions are known for their antimicrobial properties and have been used in medical care for many years to prevent and treat infection. In recent years, this technology has been applied to consumer products to prevent the transmission of infectious diseases and to kill harmful bacteria such as Staphylococcus aureus and Salmonella. In common practice, noble and other metals, metal ions, metal salts, or compounds containing metal ions, including copper ions or copper metal, having antimicrobial properties can be applied to surfaces to impart an antimicrobial property to the surface. If or when the surface is inoculated with harmful microorganisms, the applied antimicrobial material, if present in effective concentrations, will slow or even prevent altogether the growth of those microbes. For example, silver sulfate (Ag₂SO₄) as described in U.S. Pat. No. 7,579,396 (Blanton et al.), and U.S. Patent Application Publications 2008/0242794 (Sandford et al.), 2009/0291147 (Sandford et al.), 2010/0093851 (Blanton et al.), and 2010/0160486 (Blanton et al.), has been shown to have efficacy in providing antimicrobial protection in various polymer composites. The United States Environmental Protection Agency (EPA) evaluated silver sulfate as a biocide and registered its use as part of EPA Reg. No, 59441-8 EPA EST. NO. 59441-NY-001. In granting that registration, the EPA determined that silver sulfate was safe and effective in providing antibacterial and antifungal protection. In specific applications, water soluble salts, although having antimicrobial properties, may wash off of a surface rapidly and require frequent labor-intensive and costly reapplications. The use of non-water soluble pure metals would be more permanent and preferred for such purposes.

Gerba et al., Amer. J. Infection Control, 44, (2016) 689-90 describes the study of the efficacy of silver incorporated into fabrics to provide antimicrobial effects.

For example, some copper metal and copper alloys alleged to be antimicrobial agents are described in U.S. Patent Application Publication 2015/0086597A1 (Mallak et al.).

However, replacing the myriad of millions of touchable surfaces with such copper alloys or copper metal, is tremendously costly in materials and labor. Not only is the number of such surfaces staggering in volume and number, but they are present in an astonishing myriad of shapes and sizes. In addition, while the literature describes the possible use and manufacture of antimicrobial agents comprising copper nanoparticles, these materials present considerable difficulties, waste (high E-factor, or high ratio of mass of waste produced per mass of product), and dangers in their synthesis. Manufacture also creates a synthetic waste stream requiring safe disposal. Moreover, there is an increasing environmental concern associated with the use of nano- and micro-particles, in a world struggling to control nano- and micro-particles or many different synthetic materials such as polymers. The chemical synthesis of copper nanoparticles can also create surface chemistry that is toxic to human cells.

With respect to these problems, efforts have been directed to avoid the use of copper nanoparticles and to find means to cover frequently-touched surfaces with a sheet or film of an antimicrobial or anti-viral material to provide disinfecting properties without impairing the function of the covered surface. For example, U.S. Patent Application Publication 2023/0126835A (Koishikawa et al.) describes the use of an antimicrobial film that is highly light transmissive and comprises a composite of a resin film and a continuous film over the entire resin film containing both a copper oxide and a non-oxide copper formed on one side of the resin film.

U.S. Pat. No. 8,778,408B2 (Hirota et al.) proposes the use of thin metal films or laminates of metals with paper or plastic film substrates attached to touchable surfaces for antimicrobial purposes. For example, it is proposed to use a thin film containing a copper-tin alloy for this purpose.

An antimicrobial substrate having a plurality of antimicrobial metal “islands” formed in the surface of the substrate are proposed in U.S. Patent Application Publication 2010/0015193 (Inaoka et al.). Such metal islands, perhaps composed of copper metal, are small in size (for example, 5-50 nm in diameter and 50 nm or less in height). They are laid down using a metal sputtering method that is hard to control during use and is limited in the size, thickness, and variability of the copper metal pattern that can be applied to a substrate.

Despite the continuing and focused efforts in the art to provide antimicrobial articles that can be applied to surfaces, there is a continuing need to provide copper metal-containing articles that are easy and inexpensive to make, highly effective to reduce viability and transmission of various infectious agents of all types, safe for users and repeated human touching, and adaptable for application to many different touchable surfaces of various shapes and sizes. Such articles should be free of copper nanoparticles and made without sintering or post-processing of copper and copper metal sputtering. Thus, there is a need for an effective antimicrobial article that can be readily applied to a touchable surface at a concentration that is sufficient to inhibit growth and transmission of various infectious agents.

### SUMMARY OF THE INVENTION

The present invention provides an intermediate article comprising: a non-electrically conductive substrate comprising first and second opposing surfaces; and a catalytic ink disposed as a pattern of half-tone dots on at least the first opposing surface.

Such intermediate article is particularly useful for making the antimicrobial articles according to the present invention.

The present invention provides a number of advantages that provide an advance in the art of protection against contagion resulting from transmission of various infectious agents especially when they are disposed on surfaces that are open to the environment and frequently touched by humans. The antimicrobial articles of the present invention have been found to be highly effective antimicrobial agents against various infectious agents such as gram-negative and gram-positive bacteria as well as certain viruses, including but not limited to, species of the Escherichia, Staphylococcus, Pseudomonas, and Klebsiella genera, as well as the Human coronavirus 229E and the MS2 Escherichia virus. An appropriate amount of outermost electrolessly plated copper metal is present in the antimicrobial articles as a pattern of outermost copper metal features, and this pattern exhibits an excellent antimicrobial and anti-viral effects when the antimicrobial articles are “infected” by human touch with such infectious agents.

The antimicrobial articles of this invention are provided without the use of copper nanoparticles and their attendant environment waste, and the use of copper metal sputtering processes, sintering, and post-processing of copper metal, all of which procedures are generally complex, expensive, and have undesirable limitations. Moreover, in many embodiments, the antimicrobial articles of the present invention can be designed to be electrically non-conductive due to the predetermined pattern design or treatment of the electrolessly plated copper metal after electroless plating. Thus, the innate electrical conductivity of copper metal can be sufficiently diminished in some manner, so that it exhibits effective antimicrobial properties (as demonstrated in the working examples below) with minimal electrical conductivity that could produce unwanted static or interference with the function of a device to which the antimicrobial article is attached, such as to a touch screen panel. Moreover, the antimicrobial articles exhibit high light transmittance because of the specific designs of the copper metal patterns. For example, the antimicrobial articles can be created so that they exhibit light transmittance of at least 60%, or at least 75%, or of at least 85%.

The highly light transmissive antimicrobial articles of the present invention can be prepared using inventive methods that include in-line electrolessly plating of copper metal on a catalytic ink pattern or image (for example, a predetermined pattern or image that is provided using flexographic printing or another pattern or image forming technique), to form patterns of electrolessly plated copper metal in registration with the catalytic ink pattern (or image). Thus, the use of uniform copper metal foils, sheets, or paints can be avoided. Compared to known processes, the methods of this invention can be carried out at relatively lower temperatures, and thus temperature-sensitive flexible substrates such as continuous non-electrically conductive polymeric webs can be used as substrate or carrier materials. The resulting antimicrobial articles are safe for handling during manufacture and packaging, and have no adverse health impact on manufacturers or users.

For example, the inventive methods can be used to form highly antimicrobial copper metal patterns on temperature-sensitive polymeric substrates such as poly(ethylene terephthalate) (PET) within a controllable range of light transmittance with low optical haze by adjusting the electrolessly plated copper metal pattern features in size, shape (for example, in the horizontal dimensions), and thickness. By using a high-resolution printing technique to apply or print the catalytic ink, for example, using flexographic printing, followed by electroless plating of copper metal in registration, independent control of the antimicrobial copper metal pattern and copper thickness can be controlled as needed to achieve the desired antimicrobial effectiveness for specific infectious agents.

High resolution flexographic printing can be used to “print” in a roll-to-roll fashion the features of the catalytic ink pattern onto one or both opposing sides of a substrate. Copper metal can be then electrolessly plated on that pattern of catalytic ink that promotes reduction of copper ions to copper metal in registration with the catalytic ink pattern.

If desired, an adhered or peelable layer, label, or liner composed of disposable or recyclable paper or polymeric film can be placed onto the substrate “backside” (or second opposing surface). This lightly applied or adhered material can comprise a suitable adhesive and a polymeric film or paper liner that can be peeled off the substrate and the resulting highly light transmissive antimicrobial article can be applied, backside down, or adhered onto a surface of an object to be protected from infectious agents. The antimicrobial article also can be readily removed from that surface after a period of time and, if desired, replaced with a fresh antimicrobial article.

Because electroless copper plating is used in place of copper nanoparticles or copper sputtering, the resulting copper metal pattern is not contaminated with surfactants, dispersants, and stabilizers that are commonly associated with those other copper-forming processes.

Because the inventive method can be designed for in-line operations in manufacturing, various features can be provided when desired, such as the addition of copper passivation, or treatment for anti-tarnishing, and formation of light transmissive adhesive compositions on a second (backside) opposing surface of the substrate, with or without peelable polymer films or papers attached thereto.

The antimicrobial articles of the present invention are designed with flexible, highly light transmissive substrates that are lightweight and conformable to various objects to be protected. For example, they can be integrated with and conformed to windows, countertops, various display objects, touch screens, tray tables, light fixtures, medical and dental office equipment surfaces, door handles, restroom fixtures, construction hardware and fixtures, and to so many other surfaces of various sizes and shapes. Only a person's creative imagination would limit the possible uses as they are too numerous to enumerate here.

As noted in general, the pattern of the electrolessly plated copper metal features formed in the practice of the present invention can be provided by a process of first providing a catalytic ink pattern of features (for example, a pattern of unconnected catalytic ink features as described below) on which copper metal is formed by electroless plating in registration with that catalytic ink pattern. The process can have utilized some feature of the processes described in U.S. Pat. No. 10,847,887B2 (Tombs), the disclosure of which is incorporated herein by reference, in which planar antennas having a mesh design of electrically conductive copper micro-wires are described. However, in contrast to the Tombs teaching, in embodiments of the antimicrobial articles of the present invention, the copper pattern is designed for antimicrobial effects but not necessarily electrical conductivity effects that may be useful for optimum uses in antennae or touch screens according to the Tombs patent. Such design efforts can thus enable greater design flexibility and control of optical effects including light transmittance.

In many embodiments, antimicrobial copper metal patterns can be formed in registration with the catalytic ink pattern as unconnected halftone dots of designed sizes and spacings such as obtained with halftone printing, thus providing high light transmittance and very low electrical conductivity. In other embodiments, the copper metal pattern can be formed in the form of a mesh of intersecting lines, dots, and other geometric feature forms, but the electrolessly plated copper metal may have localized electrical conductivity without long-range (or entire article) electrical conductivity such that it would be essentially useless in an antennae or inside a touch screen as is known in the art.

In addition, the electrolessly plated copper metal pattern can be designed to display or exhibit a visible image, company logo, or product or service advertisement. Any copper metal pattern can be designed and disposed in registration with a catalytic ink pattern in combination with other images such as text that are printed in a manner such that copper metal is absent. However, to achieve high light transmittance that is often highly desired, the catalytic ink pattern and the electrolessly plated copper pattern in registration therewith, usually covers desirably less than 45% or even less than 25%, of the entire surface area, which corresponds generally to a light transmittance of at least 60%, or at least 75%, or of at least 85%. This result is in contrast to using the more traditional approaches of applying a continuous foil or copper coating to a surface, for example, by applying copper nanoparticles, copper metal sputtering, or copper paint.

In still other embodiments, antimicrobial articles can be prepared according to the present invention using similar processes but in which the catalytic ink pattern and copper metal pattern formed thereon may be provided on the first opposing surface of a substrate in random or designed mesh patterns comprising lines, dots, and other geometric shapes, or any combination thereof, so that some electrical conductivity may be exhibited by the outermost copper metal pattern. Such embodiments do not require that the resulting antimicrobial article be non-electrically conductive. Such antimicrobial articles can be used in situations where electrical conductivity (such as static) is not a concern.

### BRIEF DESCRIPTION OF THE DRAWINGS

FIG. 1 is a magnified image of an antimicrobial article (looking at the topmost surface) comprising flexographically printed catalytic ink and electrolessly plated copper metal in a micro-pattern (grid) disposed in registration with the catalytic ink pattern, having antimicrobial properties and prepared according to the present invention.

FIG. 2 is a magnified image of an antimicrobial article (looking at the topmost surface) comprising flexographically printed catalytic ink and electrolessly plated copper metal pattern of unconnected halftone dots disposed in registration with the catalytic ink pattern, having antimicrobial properties and prepared according to present invention.

FIG. 3 is a schematic cross-section, not to scale, of an antimicrobial article containing a pattern of halftone dots of catalytic ink and a pattern of electroless plated copper metal, in registration therewith, illustrating the antimicrobial article shown in FIG. 2, which can be prepared according to the present invention. It is to be understood that the attached drawings are for purposes of illustrating the concepts of the present invention and may not be to scale for the sake of clarity. The provided FIGS. are intended to show overall function, result, and the structural arrangement of some embodiments of the present invention, and to show various structural relationships of features thereof. A person of ordinary skill in the art will be able to readily determine the specific size and interconnections of the components of the representative embodiments of the present invention.

### DETAILED DESCRIPTION OF THE INVENTION

### Definitions

Throughout the specification and claims, the following terms take the meanings explicitly associated herein, unless the context clearly dictates otherwise. The meaning of “a,” “an,” and “the” includes plural reference, the meaning of “in” includes “in” and “on.” Additionally, directional terms such as “on,” “over,” “top,” “bottom,” “left,” and “right” can be used with reference to the orientation of the FIGURE(S) being described. Because components of embodiments of the antimicrobial articles of the present invention can be positioned in a number of different orientations, the directional terminology is used for purposes of illustration only and is in no way limiting. It should be noted that, unless otherwise explicitly noted or required by context, the word “or” is used in this disclosure in a non-exclusive sense.

Unless otherwise explicitly noted or required by context (for example, by the specified relationship between the orientation of certain components and gravity), the term “over” generally refers to the relative position of an element to another and is insensitive to orientation, such that if one element is over another it is still functionally over if the entire stack is flipped upside down. As such, the terms “over,” “under,” and “on” are functionally equivalent and do not require the elements to be in contact, and additionally do not prohibit the existence of intervening layers within a structure. The term “adjacent” is used herein in a broad sense to mean a feature that is next to or adjoining another feature.

The invention is inclusive of combinations of the embodiments described herein. References to “a particular embodiment” refer to features that are present in at least one embodiment of the invention. Separate references to “an embodiment” or “particular embodiments” do not necessarily refer to the same embodiment or embodiments. However, such embodiments are generally not mutually exclusive, unless so indicated or as are readily apparent to one of ordinary skill in the art. The use of singular or plural in referring to the “method” or “methods” is not limiting. Even though specific embodiments of the present invention have been explicitly described herein, it should be noted that the present invention is not limited to these explicitly described embodiments. In particular, any features described with respect to one embodiment may also be used in other embodiments, where compatible. The features of the different embodiments can be interchanged, where compatible.

It is to be understood that antimicrobial articles according to the present invention that are not specifically shown, labeled, or described can take various forms as would be apparent to one of ordinary skill in the art in view of the present disclosure. It is to be understood that antimicrobial articles of the present invention and components thereof can be referred to in singular or plural form, as appropriate, without limiting the scope of the present invention.

As used herein with respect to an identified property or circumstance, the qualifier “insubstantially” refers to a degree of deviation that is sufficiently small so as not to measurably detract from the identified property or circumstance. The exact degree of deviation allowable may in some cases depend on the specific context, but it is usually not larger than +10%.

Each term that is not explicitly defined in the present application is to be understood to have a meaning that is commonly accepted by those skilled in the art. If the construction of a term would render it meaningless or essentially meaningless in its context, the term definition should be taken from a standard American dictionary.

The use of numerical values in the various ranges specified herein, unless otherwise expressly indicated otherwise, are considered to be approximations as though the minimum and maximum values within the stated ranges were both preceded by the word “about.” In this manner, slight variations above and below the stated ranges can be used to achieve substantially the same results as the values within the ranges. In addition, the disclosure of these ranges is intended as a continuous range including every value between the minimum and maximum values, and unless otherwise indicated, the range end points as well.

Unless otherwise indicated, the term “antimicrobial articles,” can refer to either “non-electrically conductive antimicrobial articles,” “electrically conductive antimicrobial articles” or a combination of both types of articles, depending upon the context for their use. Where possible and necessary, the different types of antimicrobial articles will be differentiated.

For parameters defined by an “average” number or range of numbers, unless otherwise indicated, the term “average” refers to taking at least 5 different measurements at logical places, determining the sum of those values, and dividing the sum by the number of measurements taken.

In the non-electrically conductive antimicrobial articles of the present invention, the term “unconnected” in relation to “features” of a pattern of catalytic ink or of a pattern of copper metal, refers to those features not being in physical contact and are spaced apart by a distance of at least 1.5 times (1.5×) the largest dimension (for example, diameter) of an individual feature, and particularly refers to the copper metal features being spaced apart sufficiently that there is essentially no flow of electricity possible among the copper metal features. Where electrical conductivity is irrelevant to the use of the antimicrobial article, such features need not be spaced apart as described.

With respect to the antimicrobial articles of the present invention, or individual components of those articles such as the substrate or layers, the term “% light transmittance” refers to the amount of actinic light passing through an article, substrate, or layer, and this parameter can be measured using a Haze-Gard Plus haze meter that is available from Byk-Gardner USA, and given in terms of “% transmission.” As used herein to describe the present invention, but not necessarily for using the noted equipment the term “actinic light” refers to visible or actinic radiation having one or more wavelengths of at least 380 nm and up to and including 780 nm of the electromagnetic spectrum.

Surface resistivity, in ohms/□ (or ohms/square) is sometimes known as “sheet resistance” and it can be measured by using four-point probe geometry or spacing (for example, spacing of 5 mm+0.5 mm) using a four-point probe and a commercially available source meter such as the Keithley 2400 SourceMeter available from Keithley Instruments.

### Uses

The methods of the present invention are useful for making novel and inventive antimicrobial articles that can be used to remediate or effectively reduce the harmful effects or transmission of infectious agents on various surfaces (for example, fomites), and particularly on those surfaces that have frequent human touch or are difficult to sanitize. In effect, it is believed that these antimicrobial articles can be used individually or in combination to reduce the transmission of microorganisms from one person to another. The electrolessly copper-plated patterns on flexible and light transmissive substrates of the antimicrobial articles are lightweight and conformable to various surfaces. They can be integrated with, for example, windows, countertops, display screens, touch screens, tray tables, light fixtures, medical and dental office equipment surfaces, restroom fixtures, and so many other surfaces of various sizes and shapes.

In many embodiments, the antimicrobial articles are non-electrically conductive as that term is defined herein by the high sheet resistance described above, and thus have insulative properties. In other embodiments, the antimicrobial articles may comprise copper metal patterns on one or more opposing surfaces of the substrate, which are somewhat electrically conductive, or not as insulative as other embodiments. The location of use of each type of antimicrobial article of the present invention would be readily apparent to one skilled in the art.

In general, the inventive antimicrobial articles comprising the pattern of electrolessly plated copper metal can have an efficacy of killing at least 90%, or at least 95% or even at least 99%, of microorganisms comprising gram-negative bacteria and gram-positive bacteria within 120 minutes of exposure thereto under ambient temperature (20-28° C.), 30-40% relative humidity, and atmospheric pressure conditions, as described below.

In addition, some embodiments of the inventive antimicrobial articles comprising the pattern of electrolessly plated copper metal can have an efficacy of killing at least 90%, or at least 95% or even at least 99%, of microorganisms comprising enveloped viruses or non-enveloped viruses within 120 minutes of exposure thereto under ambient temperature (20-28° C.), 30-40% relative humidity, and atmospheric pressure conditions, as described below.

Additionally, some embodiments of the inventive antimicrobial articles comprising the pattern of electrolessly plated copper metal can have an efficacy of killing at least 90%, or at least 95% or even at least 99%, of microorganisms comprising the Orthocoronavirinae family including HC229E, SARS-COV-1, and SARS-COV-2 viruses, within 120 minutes of exposure thereto under ambient temperature (20-28° C.), 30-40% relative humidity, and atmospheric pressure conditions, as described below.

Moreover, some embodiments of the inventive antimicrobial articles comprising the pattern of electrolessly plated copper metal can have an efficacy of killing at least 90%, or at least 95% or even at least 99%, of microorganisms comprising the genera Pseudomonas, Escherichia, Klebsiella, Acinetobacter, and Staphylococcus within 120 minutes of exposure thereto at ambient temperature (20-28° C.), 30-40% relative humidity, and atmospheric pressure conditions, as described below.

Still other embodiments of the inventive antimicrobial articles comprising the pattern of electrolessly plated copper metal can have an efficacy of killing at least 90%, or at least 95% or even at least 99%, of microorganisms comprising the families Staphylococcaceae, Enterbacteriaceae, Enterococcaceae, Moraxellaceae, and Pseudomonadaceae within 120 minutes of exposure thereto at ambient temperature (20-28° C.), 30-40% relative humidity, and atmospheric pressure conditions, as described below.

In addition, embodiments of the inventive antimicrobial articles comprising the pattern of electrolessly plated copper metal can have an efficacy of killing at least 90%, or at least 95% or even at least 99%, of microorganisms comprising Staphylococcus aureus, Klebsiella aerogenes, Pseudomonas aeruginosa, MRSA (ATCC® 33592), Vancomycin-Resistant Enterococcus faecalis, and Escherichia coli within 120 minutes of exposure thereto at ambient temperature (20-28° C.), 30-40% relative humidity, and atmospheric pressure conditions, as described below.

Other embodiments of the inventive antimicrobial articles comprising the pattern of electrolessly plated copper metal can have an efficacy of killing at least 90%, or at least 95% or even at least 99%, of microorganisms comprising Enterococcus faecium, Staphylococcus aureus, Klebsiella pneumoniae, Acinetobacter baumannii, Pseudomonas aeruginosa, Escherichia coli, and Enterobacter species within 120 minutes of exposure thereto at ambient temperature (20-28° C.), 30-40% relative humidity, and atmospheric pressure conditions, as described below.

Moreover, some inventive antimicrobial articles comprising the pattern of electrolessly plated copper metal can have an efficacy of killing at least 99% of microorganisms comprising Staphylococcus aureus, Pseudomonas aeruginosa, Klebsiella aerogenes, MRSA (ATCC® 33592), Vancomycin-Resistant Enterococcus faecalis, and Escherichia coli within 120 minutes of exposure thereto at ambient temperature (20-28° C.), 30-40% relative humidity, and atmospheric pressure conditions, as described below.

Other embodiments of the inventive antimicrobial articles comprising the pattern of electrolessly plated copper metal can have an efficacy of killing at least 99% of microorganisms comprising Enterococcus faecium, Staphylococcus aureus, Klebsiella pneumoniae, Acinetobacter baumannii, Pseudomonas aeruginosa, Escherichia coli, and Enterobacter species within 120 minutes of exposure thereto at ambient temperature (20-28° C.), 30-40% relative humidity, and atmospheric pressure conditions, as described below.

Again, some inventive antimicrobial articles comprising the pattern of electrolessly plated copper metal can have an efficacy of killing at least 99% of microorganisms comprising Staphylococcus aureus, Pseudomonas aeruginosa, and Human coronavirus 229E within 120 minutes of exposure thereto at ambient temperature (20-28° C.), 30-40% relative humidity, and atmospheric pressure conditions, as described below.

### Antimicrobial Articles

### Non-Electrically Conductive Antimicrobial Articles:

Each inventive non-electrically conductive antimicrobial article comprises, as essential components, a suitable non-electrically conductive substrate that comprises first and second opposing surfaces, a catalytic ink disposed in a pattern (for example, a pattern comprising unconnected features) on at least one of the opposing surfaces, herein called the first opposing surface, and a pattern of copper metal (for example, comprising unconnected copper metal features) disposed in registration with the catalytic ink pattern on the same first opposing surface. Additional components of such antimicrobial articles can be present as described below.

The pattern of catalytic ink disposed on the first opposing surface can be in any shape, feature arrangement, or coverage. For example, it can be disposed on the entire area of the first opposing surface, or on only a portion of that first opposing surface, which portion can be formed in one or more locations on the entire first opposing surface, for example, in a portion of a continuous film web or belt, for example in rolled up form. In many embodiments, the pattern of catalytic ink can be disposed in the form of visible dots of suitable shapes, dimensions, and spacings. Such unconnected features would likely be separated from each other at a distance that inhibits unconnected copper metal features disposed thereon to exhibit electrical conductivity. A judicious choice of such dot patterns can be useful for controlling light transmittance of the inventive antimicrobial article. For example, such dot patterns can be halftone patterns, contone patterns, or any other pattern that would be readily apparent to a skilled worker using the teaching provided herein. In addition, halftone dots can be grouped together in a design so as to form a visible image, such as an advertising feature or a corporate logo.

In general, it is desired that the non-electrically conductive antimicrobial articles of the present invention have a sheet resistance of more than 1000 ohms/□ (ohms/square) or of more than 10,000 ohms/□, determined as described above.

### Non-Electrically Conductive Substrate:

Each non-electrically conductive substrate used in the present invention has both first and second opposing surfaces and is substantially “planar” (that is, substantially flat) in nature. However, one or both of the first and second opposing surfaces can have some curvature, valleys (or pits), ridges (or bumps), or an overall uneven surface as long as the pattern of copper metal registered on the catalytic ink pattern described below have the required antimicrobial effect. For example, a non-electrically conductive substrate can be in the form of a glass (such as a flexible glass) or resin sheet of any suitable dimension, a flexible film of plastic resin or organic polymer film (or laminate of films) comprised of one or more organic polymers, in roll form of any suitable width and length, a laminate of glass (such as a flexible glass) and one or more resins in sheet or roll form, or a breathable or loosely-woven nonadherent film or fine mesh gauze as might be used for medical dressings particularly for burn victims, and such materials can be at least partially comprised of a textile material or cellulosic material that can be mixed with various synthetic fibrous materials.

Useful substrates having the first and second opposing surfaces are generally “non-electrically conductive” or insulative, meaning that each substrate material has a surface resistivity or sheet resistance, of at least 1000 ohms/□ (ohms/square), measured as described above, or an even higher sheet resistance than the antimicrobial article itself. Some useful non-electrically conductive substrate materials, such as those comprising one or more nonionic organic polymeric materials have a sheet resistivity that may be known in the art, but if that value is not known in the art for a particular substrate material, it can be readily measured as described above. Useful organic polymeric materials are not particularly limited in composition as long as the required sheet resistivity and light transmittance are possible and they do not adversely react with the pattern of catalytic ink applied thereto and adequately adhere to that pattern. In most embodiments, the non-electrically conductive substrate is composed of a material having a light transmittance of at least 85%, or of at least 90% when measured as described above.

Useful non-electrically conductive substrates can be any material generally used for printing ink receiving layers, such as flexible glass materials, and laminates of multiple materials, stretchable or heat-set polymeric films, gauze, polyurethanes, foam dressing materials, hydrocolloid dressings, alginate dressings, polyimides, polyamides (such as nylon 6 and nylon 66), polyolefins (for example, homopolymers and copolymers of α-olefins and different comonomers, including polypropylenes and polyethylenes), polycarbonates, polystyrenes (or polymers comprising derivatives of styrene, or copolymers of styrene and other ethylenically unsaturated polymerizable monomers), polysulfones, and composites that have suitable optical transparency.

When non-electrically conductive substrates with high light transmittance are desired, organic polymer materials useful for this purpose include, but are not limited to, polyesters [such as poly(ethylene terephthalate) and poly(ethylene naphthalate)], polysulfones, polyacrylates (including homopolymers and copolymers, such as plexiglass), acetate resins, cellulose acetates (such as cellulose diacetate), vinyl resins (such as resins derived from vinyl chloride), and mixtures of such resins. Other polymeric materials (and laminates thereof) would be readily apparent to one skilled in the art and in view of the teaching herein as well as the myriad of polymeric films in the marketplace.

Particularly useful non-electrically conductive substrates can be constructed from polyester films such as poly(ethylene terephthalate) (PET), polycarbonate, or poly(vinylidene chloride) films that have been surface-treated, or coated with one or more suitable adhesive or subbing layers, the outer layer being receptive to a catalytic ink as described herein. Useful subbing layers can be composed of a polymer derived from at least vinylidene chloride polymer or of a glycidyl methacrylate-butyl acrylate co-polymer. A surface of the non-electrically conductive substrates can be treated by exposure to corona discharge, mechanical abrasion, flame treatments, or oxygen plasmas, or by coating with various polymeric films, such as a poly(vinylidene chloride) film or an aromatic polysiloxane film as described for example in U.S. Pat. No. 5,492,730 (Balaba et al.), 5,527,562 (Balaba et al.), 10,334,739B2 (Honan et al.), and U.S. Patent Application Publication 2009/0076217 (Gommans et al.), the disclosures of all of which are incorporated herein by reference, to make the surface more receptive to a catalytic ink. Useful non-electrically conductive substrates can have any desired thickness depending upon the eventual use.

It is desirable in many embodiments, that the non-electrically conductive substrate be flexible and in the form of continuous flexible polymeric webs comprised of one or more organic polymers (mixtures of such organic polymers in a single composition or multiple layers of the same or different organic polymers), so that the resulting antimicrobial articles can be manufactured in highly efficient roll-to-roll operations as described in more detail below. As would be apparent to a skilled worker from the teaching herein, such rolled up non-electrically conductive substrates can be unrolled during manufacturing and then the finished antimicrobial articles can be rolled up for storage or shipping. One or more patterns of catalytic ink and registered copper metal can be applied to at least a first opposing surface of the non-electrically conductive substrate during these operations and if desired, an adhesive and peelable polymeric film or paper also can be applied to the second opposing surface.

Moreover, as pointed out below, roll-to-roll operations are also suitable for making “intermediate” articles in which one or more patterns of catalytic inks have been formed, but which do not yet have patterns of copper metal registered therewith. Rolls of intermediate articles can be stored for electroless copper plating at a later time if desired.

Useful non-electrically conductive substrates generally have a minimum thickness of at least 25 μm and a maximum thickness of less than or equal to 300 μm for flexibility, conformability, and ease of industrial manufacture in roll-to-roll operations. A skilled worker would be able to determine an appropriate non-electrically conductive substrate thickness and polymeric material for an antimicrobial article for a given use. For non-roll-to-roll manufacturing operations, the non-electrically conductive substrate can have a thickness greater than 300 μm.

As noted above, useful non-electrically conductive substrates can be supplied in roll form for in-line processes described below and a number of flexible films of such organic polymeric materials are known in the art for this purpose including but not limited to various polyesters [such as poly(ethylene terephthalate)], polycarbonates, polyamides, and polystyrenes described above. Stretched, tentered, and heat-set poly(ethylene terephthalate) (PET) films, sheets, or rolls are particularly useful for the methods of the present invention.

The non-electrically conductive substrate can optionally be affixed, either prior to catalytic ink printing and copper plating operations or after completion of such operations, to a removable adhesive laminate or label-type material, any of which can have suitable text, printing, or other images thereon.

In addition, some useful embodiments of non-electrically conductive substrates can be formed as nonadherent films or fine mesh gauze that is sometimes designed for use as medical dressings for example for the treatment of burns. In other embodiments, the non-electrically conductive substrates can be formed of woven or non-woven textile materials composed of synthetic or naturally-occurring fibers, or a combination of such materials. Other non-electrically conductive substrates can be composed of cellulosic materials and form “papers” useful for business cards, menus, or other articles that would be readily apparent to one skilled in the art.

### Catalytic Ink:

To provide the pattern of copper metal for antimicrobial purposes, it is necessary to form a metal-containing or metal-forming “catalytic ink” in pattern-wise fashion (for example, forming a catalytic ink image) on at least the first opposing surface of the non-electrically conductive substrate, for example by using some form of printing such as a flexographic printing, inkjet printing, screen printing, or other suitable printing means. Examples of catalytic inks appropriate for use in accordance with the present invention can include catalysts such as nanoparticles of silver, gold, tin, platinum, cobalt or palladium. These catalysts are known to be effective for use with an electroless copper plating process.

A common catalytic ink for this purpose is a silver nanoparticle-containing catalytic ink, or a silver ion-containing catalytic ink in which the silver ions can be reduced to form silver nanoparticles, and the silver nanoparticles then act as catalytic sites for electroless plating and formation of copper metal from copper ions. However, copper ion-containing catalytic inks are also useful. The catalytic inks can be typically applied as an aqueous or non-aqueous liquid composition using the chosen printing means followed by heating, curing, or other operations to provide a pattern of the catalytic ink, for example, a pattern of unconnected features as described above for some embodiments.

As used herein, the term “catalytic” means that the applied chemical formulation of the catalytic ink facilitates copper metal formation from electrolessly copper plating by providing initiation sites for reducing copper metal ions [copper (+1) or (+2) ions] in the electroless plating solution to copper metal (0). If necessary suitable reducing agents can also be present in the catalytic inks.

Once applied to at least a first opposing surface of a non-electrically conductive substrate, a catalytic ink can be chemically or physically changed in some manner, such as being hardened or crosslinked, using exposure to chemistry or radiation (for example, UV or actinic radiation), and thus “cured.” A curable catalytic ink, such as a photocurable catalytic ink, can comprise reactive monomers, oligomers, or polymers that can be hardened or crosslinked under appropriate conditions, and organic solvents that can be evaporated during drying.

While silver is an electrical conductor for a wide range of industrial, medical, and consumer uses, silver metal (for example, as silver nanoparticles) also has become particularly useful to facilitate electroless plating of copper metal and other electrically-conductive metals. For example, silver seed particles can be provided in catalytic inks as reducible silver salts or organosilver compounds with a reducing agent to provide silver metal nanoparticles. Such silver ion reduction can occur in a “curing” operation along with any polymer formation or crosslinking. Representative silver ion-containing compositions that are useful as silver metal precursors in catalytic inks are described for example, in U.S. Patent Application 2015/0107474A1 (Ramakrishnan) and U.S. Pat. No. 9,511,582B2 (Jin et al.) and 10,870,774B2 (Shukla et al.), the disclosures of all of which are incorporated herein by reference.

Useful catalytic inks can be composed of various materials that allow chemical catalysis [for example, reduction of silver (+1) to silver metal (0)] to occur, including metallic nanoparticles such as silver nanoparticles dispersed within one or more organic polymers, which catalytic inks can be dried and cured as needed. This catalytic ink thus is used to provide seed metallic particles (such as silver nanoparticles) in a pattern of connected or unconnected features as described above. There can be multiple patterns of catalytic ink on a particular sample of non-electrically conductive substrate, for example, along a continuous web of the non-electrically conductive substrate, and these multiple patterns can be the same or different in chemical composition, sizes, or area of coverages. Correspondingly, each registered pattern of copper metal features can be the same or different as formed in registration on those multiple patterns of catalytic inks.

Some metal-containing catalytic inks are considered “silver precursor compositions” or “copper precursor compositions” because they comprise silver (+1) salts or reducible copper (+2) salts containing reducible silver or copper ions, respectively, suitable reducing agents (for example, cellulosic polymers or other known metal ion reducing agents), non-aqueous solvents, and other addenda known in the art.

A useful catalytic ink can be formulated as silver-containing precursor composition as described for example in U.S. Pat. No. 10,870,774B2 (noted above) and is a silver- or copper-containing precursor composition described for example in U.S. Pat. No. 10,851,257B2 (Shukla), the disclosures of both of which are incorporated herein by reference in their entirety. Such catalytic inks can be used to provide silver nanoparticles or copper nanoparticles from reducible silver ions or copper ions, respectively, and the resulting metal nanoparticles generally can have a mean particle size of from 25 nm and up to and including 750 nm. Such catalytic inks also can comprise suitable organic polymeric materials (such as cellulosic materials or vinyl acetals that may act as metal ion reducing agents), one or more non-aqueous solvents, catalytically reactive materials such as ethylenically unsaturated polymerizable monomers or oligomers (such as diacrylates and dimethacrylates), metal particle dispersing compounds, and other addenda including but not limited to, carbon black. Another useful catalytic ink is described in U.S. Pat. No. 9,851,823B2 (Bauer et al.), the disclosure of which is incorporated herein in its entirety.

Further examples of metal-containing catalytic inks and metal precursor compositions are described in numerous publications, including but not limited to, U.S. Pat. No. 9,155,201B2 (Wang et all); 9,188,861B2 (Shukla et al.); 9,207,533B2 (Shukla et al.); 9,375,704B2 (Shukla); 9,377,688B2 (Shukla); U.S. Pat. No. 9,387,460 (Shukla); 9,475,889B2 (Shukla); 9,566,569B2 (Shukla et al.); 9,587,315B2 (Shukla et al.); 9,586,200B2 (Shukla et al.); 9,586,201B2 (Shukla et al.); 9,637,581B2 (Shukla et al.); 9,653,694B2 (Shukla et al.); 9,586,200B2 (Shukla et al.); 9,592,493B2 (Shukla et al.); 9,617,642B2 (Shukla et al.); 9,624,582B2 (Shukla); 9,637,581B2 (Shukla et al.); 9,691,997B2 (Shukla et al.); 9,721,697B2 (Shukla et al.); 9,718,842B2 (Shukla); 9,809,606B2 (Shukla et al.); 9,982,349B2 (Shukla et al.); 10,087,331B2 (Shukla et al.); 10,186,342B2 (Shukla); 10,214,657B2 (Shukla et al.); 10,246,561B2 (Shukla et al.); 10,331,990B2 (Shukla); 10,314,173B2 (Shukla et al.); 10,356,899B2 (Shukla et al.); 10,358,725B2 (Shukla et al.); 10,366,800B2 (Shukla et al.); 10,364,500B2 (Shukla et al.); 10,374,178B2 (Shukla et al.); 10,370,515B2 (Shukla et al.); 10,487,221B2 (Shukla et al.); 10,472,528B2 (Shukla et al.); 10,444,618B2 (Shukla et al.); 10,763,421B2 (Shukla et al.); 11,037,692B2 (Shukla et al.); and 11,041,078B2 (Shukla), the disclosures of all of which are incorporated herein with respect to the preparation of various silver and copper precursor compositions (and resulting catalytic inks).

Alternative chemical formulations containing silver nanoparticles that can be used as “seed” particles are described in U.S. Pat. No. 8,158,032B2 (Liu et al., US '032 hereinafter) and 10,208,224B2 (Song et al.), the disclosures of both of which are incorporated herein by reference in their entirety. The described chemical formulations do not require any reactive action to provide silver nanoparticles from corresponding silver ions and they can be printed as catalytic inks on a non-electrically conductive substrate for example, using flexography to provide desired or predetermined catalytic ink patterns (or predetermined images of catalytic ink). The silver-containing compositions described in these patents can comprise organic compound-stabilized silver nanoparticles, an organic solvent medium, and a polyvinyl alcohol derivative resin of the described Formula (1) in US '032, which comprises recurring units derived from a vinyl alcohol derivative, a viny ester, and a vinyl acetal such as vinyl butyral.

In order to accommodate the various types of non-electrically conductive substrates, flexographic printing plates (printing members) generally have a rubbery or elastomeric nature whose precise properties are adjusted for a particular substrate and printed surface. Flexographic printing members are sometimes known as “relief” printing members (for example, relief-containing printing plates, printing sleeves, or printing cylinders) and are provided with raised relief images onto which ink is applied for application to a printable material. Exemplary useful printing members for flexographic printing are provided in U.S. Pat. No. 10,334,739B2 (noted above). Further details of such relief printing members are provided below.

Gravure or intaglio printing can be used to apply a catalytic ink to a non-electrically conductive substrate to provide a predetermined catalytic ink pattern (or predetermined image) by using printing members that are also relief printing members in which the image to be printed comprises depressions or recesses on the surface of the printing member, where the printing area is localized to the areas of depression that define the pattern or image.

Alternatively, a catalytic ink pattern (or predetermined image) can be formed on a non-electrically conductive substrate using inkjet printing, which technology is well developed for both consumer inkjet printing (for example, drop on demand or “DOD” printing) as well as “continuous inkjet printing” (CIJ) processes and equipment developed by Eastman Kodak Company.

For consistent print quality, the flexographic printing apparatus can be further modified to include a catalytic ink delivery control system equipped with ink-property monitoring and closed-loop process control for consistent catalytic ink rheology. The antimicrobial article can also be designed with non-electrically conductive areas that do not necessarily have antimicrobial effects, and a process for doing this is described in U.S. Pat. No. 10,847,887B2 (noted above).

A catalytic ink can be disposed in any suitable manner as described above in a pattern wise fashion to provide any desired predetermined pattern (or predetermined image) comprising connected features or unconnected features on one or both opposing sides of a non-electrically conductive substrate. Desirable patterns (or images) of unconnected features can be in the form of visible dots of variable sizes, shapes, and spacings, such as those generally known in the printing industry as half-tones or contone (continuous tones), to form various screen densities or any desired or decorative visible image. The judicious choice of dot patterns can also be useful in controlling the light transmittance through the antimicrobial article, when the non-electrically conductive substrate is optically transparent as defined above.

For example, a catalytic ink can be provided in a pattern of multiple unconnected features in a suitable manner on the first opposing surface of the non-electrically conductive substrate using various pattern-forming means such as printing techniques as described above. Flexographic printing is particularly useful in combination with an enhanced version of the proprietary KODAK SQUAREspot™ Imaging Technology. The commercially available SQUAREspot™ Imaging Technology, as used in the graphics industry for packaging, delivers the equivalent of 6400 dpi printing. To meet the high-resolution requirements of printed electronics, the enhanced version of the SQUAREspot™ Imaging Technology is capable of generating flexographic printing plates based upon the Kodak EKTAFLEX platform greater than 10,000 dpi. This remarkable level of resolution is achieved using proprietary laser imaging for the ablation of a thermal imaging layer.

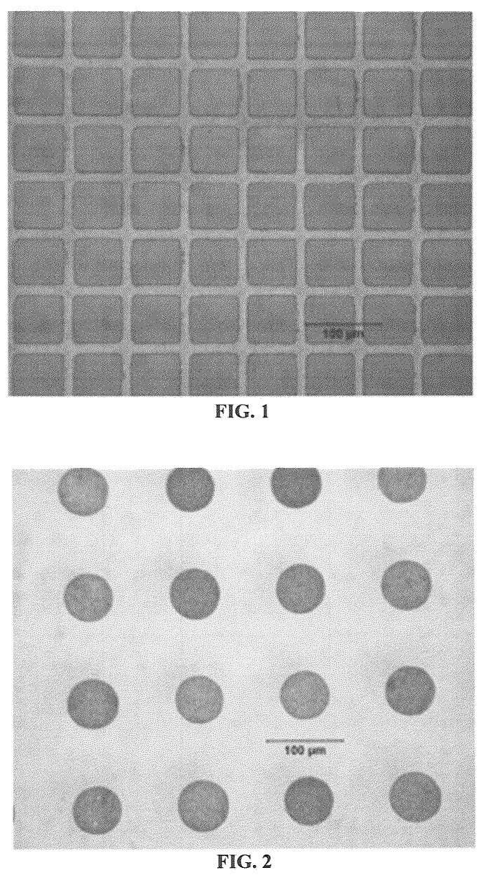

FIG. 1 shown in U.S. Pat. No. 10,847,887B2 (noted above) illustrates the application of a pattern of catalytic ink to both opposing surfaces of a continuous non-electrically conductive substrate in a roll-to-roll printing operation. Such illustrated operations can be readily modified by a skilled worker in the art to apply the pattern (for example, of unconnected features) of the catalytic ink to one opposing surface only if desired, that is to only the first opposing surface of the non-electrically conductive substrate.

Flexographic printing used according to the present invention can be carried out using any suitable commercially available flexographic printing elements (flexographic printing plates), for example the EKTAFLEX Flexographic Printing Plates or the CYREL® Flexographic Photopolymer plates available from DuPont. Generally, useful flexographic printing plates can be constructed using the technology described for example in U.S. Pat. No. 7,799,504 (Zwadlo et al.) and 8,142,987 (Ali et al.), and in U.S. Patent Application Publication 2012/0237871 (Zwadlo), the disclosures of all of which are incorporated herein by reference. In other embodiments, a flexographic printing plate can be prepared using the technologies described in the literature cited in Col. 25 of U.S. Pat. No. 10,870,774B2 (noted above).

The flexographic printing press used in embodiments of the present invention can be a multi-station press capable of printing on a first opposing surface of the non-electrically conductive substrate. Such flexographic printing press can be enhanced with camera-aided vision systems for in-press web alignment as well as station-to-station alignment and registration control. With these modifications, the pattern of copper metal not only can have the dimensions required for a given application, but the pattern can be integrated with world-class pattern fidelity and within device registration over the pattern of catalytic ink. An exemplary useful printing press for flexographic printing is provided in U.S. Pat. No. 10,334,739B1 (noted above). In other instances, smaller, commercially-available lab-size flexographic printing systems and equipment can be used in the practice of the present invention. A useful lab-size apparatus for this purpose is the IGT F1 Printability Tester (IGT Testing Systems Inc., Arlington Heights, Ill.) that is used in Inventive Examples 1 and 2 described below, as a well as a single- or multiple-station flexographic printing system such as can be obtained from Mark Andy Print Products. Other similarly useful apparatus are known in the art.

Most patterns of catalytic ink can then be dried in a suitable fashion to provide seed metal particles in the catalytic ink pattern. As noted above, some useful catalytic inks can comprise one or more photosensitive or curable monomeric, oligomeric, or polymeric precursor materials with seed metal particles. Suitable curing conditions can be readily determined by one skilled in the art. Other catalytic inks do not require curing and the components include seed metal particles in suitable polymeric binders.

A carbon black can be provided in the catalytic ink if desired, and any suitable carbon black and amount would be readily apparent to one skilled in the art from the teaching provided in Col. 16 of U.S. Pat. No. 10,870,774B2 (noted above). A representative catalytic ink useful in the practice of the present invention can comprise a dispersion of silver nanoparticles that have been formed by reduction of a silver (I) salt in the presence of a suitable silver (I) reducing agent such as a cellulosic polymer; a silver nanoparticle dispersing aid; a polyvinyl butyral or a poly(2-hydroxyethyl methacrylate) [poly (HEMA)] binder polymer; and two or more non-aqueous (organic) solvents such as propylene glycol mono methyl ether, dipropylene glycol mono methyl ether, or mixtures thereof.

The result from printing and drying (and curing if necessary) is a dried and perhaps cured pattern (or predetermined image) of a catalytic ink, for example, a dried (and perhaps cured) pattern having unconnected features of catalytic ink. As one would understand from the disclosure herein, these actions can also provide multiple (two or more) of the same or different catalytic ink patterns on a substrate such as a continuous web.

In addition to printing a catalytic ink in the desired pattern, additional ink patterns can be printed using non-catalytic inks, for example for decorative purposes such as the process described in U.S. Pat. No. 10,847,887 (noted above), the disclosure of which is incorporated herein by reference. The flexographic printing system can be used to print a plurality of patterns on the non-electrically conductive substrate in good register. In an exemplary embodiment, one of the flexographic printing plates can be used to print the catalytic ink, and another flexographic printing plate can be used to print one or more complementary or additional images using a non-catalytic ink containing a pigment (or other image-forming material) but no catalytic materials. Such non-catalytic ink does not serve as a catalyst for the electroless copper metal plating process. In this way, the one or more complementary images do not degrade the antimicrobial performance of the antimicrobial article.

The resulting article with the one or more catalytic ink patterns (that is considered herein as an “intermediate” article) can be immediately immersed in an aqueous-based copper electroless metal plating bath or solution, or it can be stored with just the catalytic ink pattern for use at a later time.

### Electroless Copper Metal Plating:

Electroless deposition or electroless plating is defined as the autocatalytic process through which metals and metal alloys are deposited onto electrically conductive and non-electrically conductive surfaces.

Any metal that will likely electrolessly plate onto the catalytic seed chemistry, such as silver nanoparticles, can be used at this point, but in most embodiments, the electroless plating metal can be for example copper (II), silver (I), gold (IV), palladium (II), platinum (II), nickel (II), chromium (II), and combinations thereof. Copper (II), silver (I), and nickel (II) are particularly useful electroless plating metals. Copper (II) is particularly useful for eventual copper metal formation and antimicrobial effectiveness according to the present invention. The one or more electroless plating metals can be present in an aqueous-based electroless plating bath or solution in an amount of at least 0.01 weight % and up to and including 20 weight % based on total solution weight.

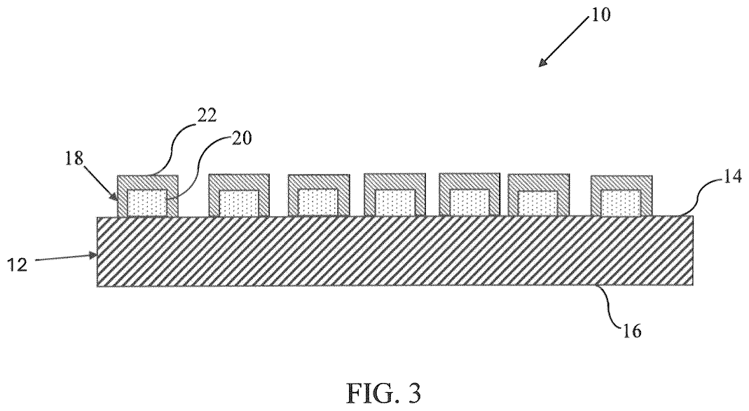

The intermediate article described above can undergo a process of electroless plating, during which metallic copper is formed in registration with only the catalytic ink patterns having connected or unconnected features, through the reduction of deposited copper salt at the catalytic sites to copper metal. Thus, the electrolessly plated copper metal will be “in registration” with and formed predominantly on the top of and on all exposed sides or surfaces of the features in the catalytic ink pattern or image (see illustration for example in FIG. 3). Thus, in general, after electrolessly plating, there is essentially no catalytic ink open to the environment.

As noted above, the pattern of catalytic ink provides catalytic seed particles for the formation of a registered pattern of copper metal during electroless plating operations. Such electrolessly plated copper metal must be provided “in registration” or predominantly on top of, the pattern (or image) of catalytic ink so that none to very little (less than 10 weight %) of the electrolessly plated copper metal resides in direct contact with the opposing surface of the non-electrically conductive substrate. In general, the pattern of copper metal can comprise multiple unconnected features (for example, halftone dots or other shapes) disposed in registration with the pattern of catalytic ink having the same pattern of multiple unconnected features. Electroless copper metal plating is a well-known technology and has been used for decades within Eastman Kodak Company and in other manufacturing companies using web-based or continuous operations in roll-to-roll format. Such operations can comprise a customized electroless plating system with a multiple-section processor providing copper metal deposition over a range of micro-pattern (unconnected feature) heights. Such electroless copper metal plating system can comprise fully touchless web transport, meaning that the non-electrically conductive substrate never contacts a roller within the plating system. An exemplary useful electroless copper metal plating system is provided in U.S. Pat. No. 10,334,739B2 (noted above). Such electroless copper metal plating system can also include a passivation section where the pattern (or image) of registered copper metal (for example, a copper pattern or image comprising unconnected copper metal features) is chemically passivated against oxidation and corrosion and can also be treated for reflection and color-control.

General details of electroless copper metal plating baths containing copper ions and other chemical components are described for example in Cols 34-35 of U.S. Pat. No. 9,851,823B2 (Bauer et al.) and Cols. 26-27 of U.S. Pat. No. 10,870,774B2 (noted above) and as well as by Malloy et al. in Electroless Plating: Fundamentals and Applications, 1990. A useful aqueous electroless plating solution or bath is an electroless copper (II) plating bath that contains an aldehyde such as formaldehyde as a reducing agent. Ethylene diamine tetraacetic acid (EDTA) or salts thereof can be present as copper complexing agents as described for example in U.S. Pat. No. 9,512,243B2 (Brust et al.). Electrolessly plating copper metal can be carried out at room temperature, or at moderately higher temperatures, for several seconds and up to several hours depending upon the desired deposition rate and plating copper thickness.

Commercially available copper electroless plating baths (solutions) can be obtained from companies such as Atotech and MacDermid-Alpha (formerly MacDermid-Enthone).

A representative schematic side view of a roll-to-roll electroless plating system is illustrated in FIG. 2 of U.S. Patent Application Publication 2016/0168713 (Reuter et al.), the details of which plating system and the remaining disclosure of which are incorporated herein by reference.

Electroless copper metal plating can also be performed in a batch format (that is, non-roll-to-roll) using the above mentioned chemistries and steps in stand-alone tanks or beakers. Alternatively, a copper metal plating solution as described above can be sprayed, rolled on, or coated uniformly onto the catalytic ink pattern.

In some configurations, after electrolessly plating the catalytic ink pattern with a metal such as copper, the resulting antimicrobial article can be treated with or put through a second bath for passivation, to apply a darkening or anticorrosion agent to the copper pattern(s) or image(s). In an exemplary process, palladium is used as a darkening and anti-corrosion agent. Darkening palladium chemistries are available commercially, such as TELOTECH BLACK METAL P1 from Atochem. In another exemplary process, CU-56 (a benzotriazole antioxidant that inhibits oxidation) is used as the anti-corrosion agent in a passivating solution.

Care should be taken to minimize the thickness of additional metals deposited during these processes so as not to negatively impact the antimicrobial effectiveness of the resulting antimicrobial article, or to diminish its light transmittance.

After electrolessly plating, the antimicrobial articles having the resulting patterns (or images) of antimicrobial copper metal can be rinsed using distilled water or another aqueous solution to remove any residual electroless plating chemistry or passivating chemistry.

Some embodiments of antimicrobial articles of the present invention are non-electrically conductive because of the way they are made. In such embodiments in which the predetermined catalytic ink pattern and electroless plated copper metal pattern in registration therewith comprise unconnected features, such as unconnected copper metal features (for example, unconnected copper metal dots), having an average total copper thickness of at least 0.4 μm or of at least 0.5 μm, and up to and including 2 μm or up to and including 4 μm.

In addition, such unconnected features of the catalytic ink pattern and the registered copper metal pattern comprising unconnected copper metal features disposed thereon (for example in the form of unconnected dots) can have an average largest horizontal dimension (for example a diameter) of at least 10 μm or of at least 15 μm, and up to and including 60 μm or up to and including 100 μm. This largest average horizontal dimension can be a width or length, or a diameter, of the unconnected features, and it can be determined by measuring at least 5 different unconnected features and then taking an average of those at least 5 measurements. The dimensions can be observed using an optical microscope and known procedures.

It is possible that multiple catalytic ink patterns (or images) and registered copper metal patterns can be present on only portions of an opposing surface of the non-electrically conductive substrate, or in individual sections thereof. The multiple patterns can cover the entire first opposing surface of the non-electrically conductive substrate, or only a portion thereof.

The antimicrobial articles of the present invention (whether non-electrically conductive or electrically conductive as described below) can have a total average (usually dry) thickness of at least 0.05 mm and up to and including 3 mm or even up to and including 5 mm. These dimensions can be varied depending upon the average thickness of the chosen non-electrically conductive substrate and the average thickness (vertical dimension) of the antimicrobial patterns (or images) described above. Such an “average” feature can be determined by measuring the thickness (in a dry state) of a specific antimicrobial article in at least 5 different positions using known equipment and procedures, and then calculating an average value. If an antimicrobial article also comprises an adhered peelable backing or a polymeric film or paper (as described below), the overall dry thickness can be greater than 2 mm and up to any practical thickness based on the substrate materials used, any adhesives, any peelable polymeric films or papers, and the various patterns positioned thereon.

The antimicrobial articles of the present invention can be generally non-electrically conductive elements that comprise the catalytic ink pattern as described above, which comprises multiple unconnected or interconnected lines, shapes, or a combination thereof; and the electrolessly plated pattern of copper disposed on the catalytic ink pattern in registration therewith. Such antimicrobial articles generally exhibit a sheet resistivity of at least 1000 ohms/□ or of at least 10,000 ohms/□, determined as described above using a four-point probe and a source meter. In some embodiments, such antimicrobial articles comprise unconnected features (such as halftone dots) in the catalytic ink pattern and unconnected copper metal features, on the first opposing surface.

The antimicrobial articles of the present invention can be prepared to comprise a suitable adhesive composition that is disposed on at least a portion of the second opposing surface of the non-electrically conductive substrate, or on the opposite surface from the antimicrobial copper metal pattern. Such adhesive compositions can be pressure-sensitive adhesive compositions designed as part of or attached to a peelable polymeric film or paper, such as a removable liner, protective layer, or release layer that is disposed on at least a portion of the second opposing surface. This peelable polymeric film or paper can be designed so it can be easily peeled off, for example, with or without the pressure sensitive adhesive composition or another type of adhesive, when a user wants to apply the second opposing surface of the antimicrobial article to a particular object. These useful adhesive compositions may also be known in the art as “removable adhesives,” “temporary adhesives,” or “mounting adhesives.” They typically comprise one or more acrylic resins, silicone resins, or rubbery resins and various compositions that would be readily known in the art for such purposes. Such adhesives can be strong enough to keep the liner, protective layer, or release layer intact until active peeling is carried out, and strong enough to provide adherence to an object to be covered with the antimicrobial article so it is not easily removed with frequent human touching.

Another purpose of such peelable polymeric film or paper is to provide protection of the antimicrobial articles of the present invention, especially when provided in stacked form or in rolled up webs. Peelable papers can be formed from any suitable cellulosic material that can be resin coated or uncoated on one or both sides. Examples of peelable polymeric films and papers are well known in the art and are utilized on many household and industrial products. They are particularly useful for application in roll-to-roll operations.

In some embodiments, the adhesive composition described above can be disposed on the second opposing surface of the antimicrobial article independently of a peelable polymeric film or paper using known coating or disposition techniques of suitable pressure sensitive or releasable adhesive compositions. But, as noted above, the adhesive composition can be an integral uniform or discontinuous coating on one side of the peelable polymeric film or paper, the resulting “composite” peelable polymeric film or paper can be applied to the second opposing surface of the non-electrically conductive substrate after electrolessly copper metal plating.

For example, a peelable polymeric film or paper can be disposed on at least a portion of the second opposing surface with a pressure-sensitive adhesive that is defined in more detail above.

Such peelable polymeric films or papers, designed with or without an integral adhesive, can cover all or only a portion (such as the perimeter or other predetermined area) of the second opposing surface.

To illustrate some embodiments of the present invention, FIGS. 1 and 2 are magnified images (looking at the topmost surface) of embodiments of antimicrobial articles showing the patterns (or images) of copper metal. Illustrative methods for preparing such antimicrobial articles are described below in the Examples.

FIG. 3 illustrates a cross-sectional view, not to scale, of antimicrobial article 10 that would have the topmost view of halftone dots shown in FIG. 2, which antimicrobial article 10 comprises non-electrically conductive substrate 12 that has first opposing surface 14 and second opposing surface 16. On first opposing surface 14 are disposed a pattern of multiple composite features 18 composed of a catalytic ink pattern (or image) of multiple catalytic ink features 20 on which a copper metal pattern of multiple copper metal features 22 is disposed in registration therewith. Multiple copper metal features 22 essentially cover the tops and lateral sides or surfaces of multiple catalytic ink features 20. In practice, individual composite features 18 may not have exactly the same size or shape, and can be spaced apart sufficiently to inhibit electrical conductivity among composite features 18.

### Electrically Conductive Antimicrobial Articles:

The method of the present invention also can be used to provide antimicrobial articles that are more electrically conductive compared to the non-electrically conductive articles described above. Such electrically conductive antimicrobial articles are defined herein as exhibiting a sheet resistance of less than 1,000 ohms/□ or less than 100 ohms/□, as measured in the manner described above. The patterns or images of antimicrobial copper metal can be provided in such antimicrobial articles using teaching described in various publications, for example U.S. Pat. No. 10,847,887B2 (noted above), the disclosure of which is incorporated herein by reference. The non-electrically conductive substrate, catalytic inks, electrolessly plated copper metal, and other features described above for the non-electrically conductive antimicrobial articles also can be used here. It is also important to understand that such electrically conductive antimicrobial articles can be made using non-electrically conductive substrate materials, forming catalytic ink patterns, and then copper metal plating.

Such electrically-conductive antimicrobial articles can also comprise additional features, namely a peelable polymeric film or paper disposed on all or a portion of the second opposing surface of the substrate, and this peelable polymeric film or paper can be accompanied by a suitable adhesive (described above). These electrically-conductive antimicrobial articles can be used similarly to be applied to surfaces on which infectious agents can be found or deposited. However, as one skilled in the art would understand, static electricity may be generated in such antimicrobial articles and so the application of such antimicrobial articles to various electricity-sensitive objects such as devices with touch screens would be limited.

### Methods for Preparing Antimicrobial Articles

The antimicrobial articles, and particularly the non-electrically conductive articles of the present invention, can be prepared using at least the following steps A) through C) and optionally step D), in order, unless otherwise indicated.

In step A), a suitable non-electrically conductive substrate comprising first and second opposing surfaces, can be provided in any suitable form or size, such as in roll form. Such non-electrically conductive substrates and their possible chemical compositions are described above. A skilled worker in the art would understand how to manufacture such non-electrically conductive substrates from the appropriate polymeric chemicals, or to purchase them from a suitable supplier. In many embodiments of the present invention, a rolled up form of a flexible (for example, flexible film) non-electrically conductive substrate can be provided for an in-line process for making the intermediate products or antimicrobial articles. For example, a non-electrically conductive substrate can be provided in step A) as a roll comprising a flexible polymeric material or web comprising one or more organic polymers (for example, continuous PET films) of any suitable width. Such flexible polymeric materials can be composed of one or more layers (that is, as a laminate) comprising the same or different polymeric composition as long as the dimensional and light transmission requirements described above are met. Examples of such polymeric materials are described above.

It is also possible for a non-catalytic and non-electrically conductive image to be applied to the first or second opposing surface of the non-electrically conductive substrate after step A) and before step C). Such non-catalytic and non-electrically conductive images can comprise text, logo(s), monochrome or polychrome images of all types, or any combination thereof, as long as they will survive the operations carried out in steps B), C), and D). Such non-catalytic and non-electrically conductive images can also be provided on the “backside” of a peelable polymeric film or paper that is adhered to the second opposing surface of the non-electrically conductive substrate after step D).

Following step A), step B) calls for patternwise disposing at least one pattern (or forming at least one image) of a catalytic ink onto at least a portion of the first opposing surface of the non-electrically conductive substrate. As described above, step B) can be carried out in a number of ways, using any of various suitable catalytic inks, also as described above (for example, flexographic printing, screen printing, and inkjet printing). However, most embodiments of the present invention are carried out using flexographic printing with flexographic printing plates to provide a suitable catalytic ink onto at least a portion of the first opposing surface in the form of one or more of the same or different catalytic ink patterns or images. As described above, multiple catalytic ink patterns can be formed on the first opposing surface using continuous webs of non-electrically conductive substrates to form intermediate articles.

In some embodiments, the one or more patterns of catalytic ink so disposed comprise unconnected features as described above for example, as the same or different patterns of unconnected halftone dots on which unconnected features of copper metal features are disposed in registration [see step C) below]. Moreover, when the catalytic ink used in step B) comprises a curable catalytic ink composition as described above, the inventive method can further comprise step B′) after step B) to “finish” the intermediate articles. Alternatively, such step B′) curing can be carried out between steps B) and C) that are carried out in immediate sequence. Step B′) comprises at least curing (and likely also drying), the one or more applied patterns of curable catalytic ink. As noted above, curing can be carried out by exposure to suitable heat, or suitable actinic radiation, or both heat and actinic radiation. For example, some catalytic ink compositions are photosensitive and curing can be accomplished by suitable exposure to infrared or ultraviolet radiation of a suitable wavelength, duration, and energy level, all of which would be readily apparent to one skilled in the art who understands the particular chemical composition of the catalytic ink and its curing properties.

After step B) and optional step B′), the resulting intermediate articles (particularly those having patterns of unconnected features, such as halftone dots) can be rolled up for shipment or later use according to the present invention [thus, using at least step C) and optional step D)] or for other manufacturing purposes totally unrelated to forming antimicrobial articles. Such intermediate articles can be rolled up with a liner sheet of any suitable type so that the front of an intermediate article is separated from a rolled up surface of the backside of the intermediate article. Such liner sheets would be readily apparent to one skilled in the art.

When the desired antimicrobial article is to be non-electrically conductive as describe above, and once the one or more patterns of catalytic ink are provided (for example, one or more patterns comprising unconnected features), and optionally dried and/or cured to provide an intermediate article, step C) is carried out by electrolessly plating copper metal as one or more patterns in registration on the one or more catalytic ink patterns (or images), thereby providing one or more patterns of electrolessly plated copper metal (for example as unconnected copper metal features). It is desirable that the unconnected copper metal features are plated on only the unconnected features of the catalytic ink patterns (thereby providing unconnected copper metal features in the form of “stacked” or unconnected composite features as illustrated in FIGS. 2 and 3). The details of electrolessly plating copper metal are described above. The result of carrying out steps A), B), and C) in sequence is to form a non-electrically conductive antimicrobial article for antimicrobial purposes according to the present invention. The various features of the preferred use of unconnected features are described in more detail above.

As noted above, in some embodiments, the catalytic ink pattern(s) and the registered pattern(s) of copper metal can be provided in steps B) and C) on one or more portions of the area of the first opposing surface of the non-electrically conductive substrate. The resulting non-electrically conductive patterns can be provided multiple times, and they can be the same or different, on the first opposing surface. For example, the antimicrobial article can be provided as a roll comprising a flexible polymeric web as the non-electrically conductive substrate, and one or more of the same or different electrolessly plated copper metal patterns disposed in registration with one or more of the same or different catalytic ink patterns. It can be useful to carry out a step D) for passivating the electrolessly plated copper metal pattern(s) for various purposes including protecting them from tarnishing, copper oxidation, or other corrosion or, to reduce visual reflectance (blackening), using known procedures and equipment as described above. It is important, however, that such step D) adversely does not reduce the antimicrobial effectiveness of the copper pattern(s) treated in such a manner. Step D) can be followed by rinsing the antimicrobial article with suitable aqueous solutions such as water as described above.

As noted above, in some embodiments, after step C) or after step D) if it is carried out, an adhesive composition can be provided on the second opposing surface. Such adhesive composition can be used to adhere the antimicrobial article to a suitable article as described above, or it can be used to adhere a peelable polymeric film or paper, as described above, for protective purposes until the antimicrobial article is to be used, or it can be used for both purposes. The adhesive and peelable polymeric film or paper can be provided in the same or separate operations. Such operations would be readily accommodated in a continuous operation where a continuous web of antimicrobial article is produced, and either slit into suitable pieces or sheets or rolled up for later use after all operations are completed.

It is also possible that one or more patterns (or images) of catalytic ink can be formed along with drying and/or curing on a first opposing surface of a continuous web of substrate [using steps A) and B)] and this intermediate article can be rolled up for further use at a later time to carry out at least step C) and optionally step D).

In any of these embodiments, the antimicrobial article of the present invention can be cut into sheets of predetermined sizes, or finished into roll form, especially where there is a peelable polymeric film or paper on its backside in contact with the rolled up front side containing the one or more patterns of copper metal.

At any time after step C), and optional step D), the method can include step E) providing an adhesive composition on at least a portion of the second opposing surface of the non-electrically conductive substrate. Useful adhesive compositions are described above. Such adhesive compositions can be provided as part of a peelable polymeric film or paper as described above, or subsequent step F) can be used to apply such peelable polymeric film or paper to the adhesive composition provided in step E) to at least a portion of the second opposing surface. At any appropriate time during the method of the present invention, as determined by one skilled in the art, a non-catalytic ink image of any type (text, numbers, logos, pictures, or other suitable images) can be applied or formed on either or both of the first opposing surface and the second opposing surface of the non-electrically conductive substrate.

### Use of Antimicrobial Articles

In general, the antimicrobial articles of the present invention can be used for mitigating microbial activity (including contact with or transmission from human touching). This can be accomplished by applying an antimicrobial article of the present invention of appropriate size and shape to an object, perhaps to be adhered to the object with an adhesive on the second opposing surface after a peelable polymeric film or paper has been removed, to kill as much antimicrobial life transmitted to the object and to inhibit the transfer of antimicrobial life from the object to anyone thereafter touching it.

For example, the antimicrobial articles of the present invention can be integrated with or adhered to surfaces, such as windows, countertops, display screens, and tray tables. Other surfaces can include hospital bedside trays, rails, chairs, walls, and door handles, as well as surfaces in clinics, dental offices (trays, computer keyboards, headrests). Other potential surfaces may be, but are not limited to, trays and armrests in airplanes, shopping cart handles, and public touchscreens such as in banks or automated bank machines.

For example, microbial activity can be mitigated by applying an antimicrobial article of the present invention to an object to inhibit the transfer of antimicrobial life from the object to anyone thereafter touching the object using any of the antimicrobial articles according to the present invention, that is, with either unconnected features or connected features in the pattern of electrolessly plated copper metal.

Such mitigating action can further comprise removing a peelable disposable polymeric film or paper from the second opposing surface of the non-electrically conductive substrate before applying the antimicrobial article to the object. The applied antimicrobial article is used to inhibit the transfer of various microorganisms including gram-negative and gram-positive bacteria and enveloped and non-enveloped viruses described in more detail herein.

Objects that can be protected using the present invention include but are not limited to, touch screen devices, each of which comprises a touch screen surface that is surrounded by one or more non-touch screen surfaces, which one or more non-touch screen surfaces are covered by an antimicrobial article according to the present invention. Such surfaces can be protected by forming a flexible sheet of the antimicrobial article onto the non-touch screen surfaces, either by hand or in an automated manner using industrial equipment.

Other objects to be protected include paper or film articles comprising a paper or film substrate, optionally comprising images on at least one of two opposing surfaces, and having on at least a portion of at least one of the two opposing surfaces, an antimicrobial article. Such objects can be sheets or paper, menus, business advertisements, business cards, or any other flat sheet that is readily handled by people and can carry microorganisms from one person to another. Other objects to be protected include tray tables and frequently touched door glass and push bar surfaces in public areas.

Some objects of this type can include a woven textile material as the substrate. Other objects can include a thin mesh gauze or woven film that could be useful as medical gauze, tape, or bandage materials.

Further details of the use of the antimicrobial articles are provided above, including the potential efficacy of killing various families, genera, or species of microorganisms (or pathogens), under ambient temperature, relative humidity, and atmospheric pressure.

The present invention provides at least the following embodiments and combinations thereof, but other combinations of features are considered to be within the present invention as a skilled artisan would appreciate from the teaching of this disclosure:

1. An intermediate article comprising:
a non-electrically conductive substrate comprising first and second opposing surfaces; and
a catalytic ink disposed as a pattern of half-tone dots on at least the first opposing surface.

2. The intermediate article of embodiment 1 that is in roll form.

3. The intermediate article of embodiment 2 in roll form that further comprises a liner sheet between the second opposing surface of the non-electrically conductive substrate and the catalytic ink pattern of half-tone dots.

4. The intermediate article of any of embodiments 1 to 3, wherein the catalytic ink comprises an organic polymer and silver nanoparticles.

5. The intermediate article of any of embodiments 1 to 4, having a light transmittance of at least 60%.

6. The intermediate article of any of embodiments 1 to 5, having a light transmittance of at least 75%.

7. The intermediate article of any of embodiments 1 to 6, wherein the non-electrically conductive substrate is a flexible film and comprises one or more organic polymers.

8. The intermediate article of any of embodiments 1 to 7, wherein the non-electrically conductive substrate comprises poly(ethylene terephthalate).

9. The intermediate article of any of embodiments 1 to 7, wherein the non-electrically conductive substrate comprises a nonadherent film or fine mesh gauze.

10. The intermediate article of any of embodiments 1 to 79, wherein the non-electrically conductive substrate comprises a fabric.

11. The intermediate article of any of embodiments 1 to 7, wherein the non-electrically conductive substrate comprises a cellulosic material or a flexible glass.

The following Examples are provided to illustrate the practice of this invention and are not meant to be limiting in any manner. The following materials and procedures were used in the practice of the working examples.

### X-Ray Fluorescence (XRF) Measurement:

The antimicrobial samples that were prepared with electrolessly plated copper metal were analyzed for copper and/or palladium content using X-ray fluorescence (XRF) that is the emission of characteristic “secondary” (or fluorescent) X-rays from a material that has been excited by being bombarded with high-energy X-rays or gamma rays. This method is widely used for elemental analysis and chemical analysis, particularly in the investigation of metals. After copper metal plating, the copper laydown was analyzed using an S2 Ranger XRF from Bruker (Serial No. 208328). For this evaluation, samples were cut to fit the standard 5 mm diameter sample holders with a 3 mm diameter window for analysis. Each sample was placed in the holding tray, copper side down. The instrument was then programmed to initiate the metal evaluation method (for copper, palladium, or silver). The results are stated in units of μg/cm² and represent the total copper or palladium amount as averaged over the entire 3 mm diameter sample area.

### Transmittance Measurements:

The total light transmittance of samples of each antimicrobial article was measured using a commercially available haze meter (Haze-Gard Plus produced by BYK-Gardner). To complete these measurements, each sample was illuminated with a beam of light held perpendicular to the sample surface and the resulting transmitted light was collected within an integrating sphere using an imbedded photoelectric detector. The total amount of light transmitted through each sample and the amount of light scattered at angles greater than 2.5° were quantified and recorded. The Haze-Gard Plus instrument conforms to ASTM D-1003, but use of the instrument eliminates many manual steps that are included in that standard.

### Resistance Measurement:

The electrical conductivity of each inventive antimicrobial article was determined by measuring the resistance of an article sample. Resistivity and conductivity are intensive properties of materials, with electrical conductivity being the inverse of resistivity. For each measurement, a sample of an antimicrobial article having dimensions of at least 75 mm×75 mm, was placed on a glass surface and the resistance was measured using a commercially available 4-point co-linear probe array with a probe diameter of 2.5 mm and an average probe spacing of 5.3 mm connected to a commercially available Keithley 2400 source meter (probe points spaced at 5 mm±0.5 mm). Electrical resistance measurements were performed at multiple locations on the antimicrobial article sample and the readings were averaged to provide an electrical resistance in ohms. The electrical resistance measured in ohms can be converted to sheet resistance in ohms per square (ohms/□) by multiplying the measured resistance by 4.532 (the correction factor for the specific geometry of the instrument). The use of sheet resistance in ohm/□ is suitable parameter of electrical conductivity for such antimicrobial articles because they are in the form of thin “films” and the thickness dimension has little impact on the overall electrical resistance measurement.

### Catalytic Ink (INK A):

The catalytic inks, including photocurable INK A, generally include a catalytic material that can facilitate electroless copper plating to provide an antimicrobial copper pattern, in registration with the applied catalytic ink pattern. Examples of catalytic inks appropriate for use in accordance with the present invention include catalytic materials such as nanoparticles of silver, gold, tin, platinum, cobalt, or palladium that are known to be effective for use with an electroless copper plating process such as that described herein.

The catalytic ink used in the following working examples is described in detail in Col. 45 of U.S. Pat. No. 9,851,823B2 (noted above). INK A comprised the following components formed into a 100 g aliquot: 14.4 g of epoxy acrylates (CN 153 from Sartomer), 9.9 g of poly(ethylene glycol) diacrylate (Mn of 258, Sigma-Aldrich), 2.1 g of poly(ethylene glycol) diacrylate (Mn of 575, Sigma-Aldrich), 10.8 g of pentaerythritol tetraacrylate (Sigma-Aldrich), 0.8 g of triaryl sulfonium salt hexafluoro phosphate mixed in 50% propylene carbonate (Sigma-Aldrich), 0.8 g of triaryl sulfonium salt hexafluoroantimonate mixed in 50% propylene carbonate (Sigma-Aldrich), 2.4 g of free radical photoinitiator hydroxycyclohexyl phenyl ketone (Sigma-Aldrich), 1.2 g of free radical photoinitiator methyl-4′-(methylthio)-2-morpholinopropiophenone (Sigma-Aldrich), 19.5 g of silver nanoparticles (Novacentrix, 20-25 nm average particle size, Ag-25-ST3), 1.1 g of carbon nanoparticles (US1074 from US Nano), 0.001 g of 9-fluorenone (Sigma-Aldrich), and 35 g of 1-methoxy isopropanol (Sigma-Aldrich) solvent, wherein the catalytic active component are the silver nanoparticles.

### Flexographic Printing Member:

The flexographic printing member used for printing the INK A was prepared from a sample of commercially available Kodak Flexcel NX flexographic printing plate precursor (Eastman Kodak Company) that had been imaged using a mask that had a predetermined pattern written using the Kodak SQUAREspot™ laser technology at a resolution of 12,800 dpi. The flexographic printing plate precursor was UV radiation exposed and processed (developed) using known conditions suggested for these flexographic printing members by the manufacturer. The resulting flexographic printing plate was 1.14 mm thick (including the PET film support). The backing tape used to mount this flexographic printing plate to a printing form cylinder was 1120 Beige tape (3M Company) that was 20 mil (0.051 cm) thick having a Shore A hardness of 55.

The printing surface of the relief image pattern in the resulting flexographic printing member used for printing INK A for Inventive Examples 1 and 2 included multiple patterns, each comprising 10-50 μm diameter, essentially circular dots that were uniformly spaced with a variety of spacings so as to provide a range of print screens ranging from 1% to 70%.

The printing surface of the relief image design in the flexographic printing member used for printing INK A in Inventive Examples 3-9 and in Comparative Example 2 as follows included a pattern of intersecting lines of average line widths of between 4 and 21 μm and an average pitch of between 62 and 375 μm (depending on the specific pattern).

### Surface Abrasion Protocols:

Each of the EPA abrasion testing protocols referred to herein include sections outlining the materials, equipment, cycles and sequences to abrade the samples physically and chemically. The intent is to subject the test samples (also referred to as carriers or coupons) to real-world wear associated with sponge cleaning with specified cleaning solutions. Microbiology testing with unabraded and abraded samples is intended to show the durability of the test samples, demonstrating that the stated efficacy is maintained after normal cleaning expected in EPA's use patterns (Commercial, Institutional and Industrial, Residential and Public Access premises, and Medical premises).

There are differences between the two abrasion protocols in the cycles and sequences that test samples are subjected to. In particular, the US EPA MB-40 protocol specifies each sample to be both wet and dry abraded, instead of the previous specification to do one or the other (wet vs dry) to a given test sample.

### Microbiology:

The United States Environmental Agency (“US EPA”) publishes microbiological protocols as part of the data submission requirements for biocidal surfaces intended for uses where reducing risks of pathogen transmission are desired. Its regulating authority comes from the US Federal Insecticide, Fungicide and Rodenticide Act (FIFRA) that mandates that the US EPA determines that registered products are effective and pose no harm to public health or to the environment.

Such biocidal surfaces are called fomites and include a wide variety of applications. As noted above, a fomite is defined as any inanimate surface that when contaminated with an infectious agent (such as pathogenic bacteria, viruses or fungi) can serve in their transmission. Examples of fomites are described above and the means of transmission of an infectious agent are also described above.

Submission of such data is required by US EPA for the designation of a Public Health Claim (PHC) associated with the biocidal surface. A PHC is a specific quantitative statement of efficacy, such as “This surface kills 99.9% of E Coli within 2 hours of contact between routine cleanings.” Making such claims without approval is a violation of US federal law and can be severely penalized.

Various microbiology testing protocols, each relevant at the time of testing, were used as described below.

All of the microbiology testing protocols had the following features:
1. A detailed specification for the preparation of the inoculum from certified sources.
2. Specific bacterial test organisms, such as: Gram positive Staphylococcus aureus (ATCC® #6538), and Gram Negative Pseudomonas aeruginosa (ATCC® #15442), and viral test organisms such as Human coronavirus 229E (“HC229E”).
3. Application of 20 μl of inoculum to 1″×1″ (2.54 cm×2.54 cm) carriers (or plates or samples).
4. An exposure period of 2 hours (unless otherwise stated) in controlled temperature (22° C.) and humidity (30-40% relative humidity, RH) conditions.
5. Recovery with a neutralization solution proven by separate testing to be effective in stopping the antimicrobial action of the specific biocides used on the surface.
6. Enumeration using Filter Plating and 72-hour incubation periods at 37° C., with an additional incubation of 48 hours for any plates showing no bacterial colonies.
7. Success criterion for reported results of log kill or % kill from the negative control.

Efficacy performance standards vary widely and are (1) context (Food Preparation, Clinical, Public Transport, etc.) and (2) time sensitive. Surface disinfectants (liquids) are held to a very high standard (>5 log within 10 minutes, as an example). Antimicrobial coated surfaces are generally governed by the EPA performance standard of 3 log reduction or 99.9% (or greater) within 2 hours.

As noted above, the EPA protocol calls for reporting Log Reduction values using a standard microbiological technique known as filter plating. In the evaluations described below, untreated control and samples of the invention (“treated”) were inoculated with specific microorganisms of a defined concentration, exposed to specified conditions of temperature, humidity, and time, neutralized, and then sonicated to recover any surviving organisms. The recovered solution was then serially diluted by factors of 10 in triplicate, filter-plated separately (3 for each dilution), and incubated for a given time and temperature.

After incubation, the filter plates were observed with a plate counter (with magnification) and observable colonies, referred to as colony forming units (CFU), were counted. Multiple dilutions were used in order to obtain a dilution where numbers can be counted between 25 and 250. Values above this value are reported as “Too numerous to count=TNTC” and that dilution was not used. Values below this range are reported as described below.

As noted in the tabulated results shown below, “LOD” refers to “Limit of Detection” that is a threshold of amount of microorganisms that can be detected using the means (that is, dilutions) used in the protocol. As an example, for plates having 1 ml of a 1:10 dilution, the LOD was calculated as 1 (Minimum Observable cell count) multiplied by 10 (Dilution factor)=10 CFU/ml. If the average counts of the triplicate plates were less than 1, as in the values of (0,0,1), the result is considered below the reportable threshold, and so are reported as “<10 CFU/ml”. When reporting Log Reduction values, this cell count was subtracted from the control cell count, and the calculated log reduction value is noted as “Greater than the reported value.”

Moreover, “LOQ” refers to “Limit of Quantification” that is the statistically significant limit of 25 (refer to the Bacteriological Analytical Manual (BAM)|FDA at BAM Chapter 3: Aerobic Plate Count|FDA). Historical studies have shown that the error escalates rapidly below this value. For example, for plates with 1 ml of a 1:10 dilution, the LOQ is 25 multiplied by 10 (Dilution Factor)=250 CFU/ml. If the average counts of the triplicate plates are less than 25, as in the values of 16, 18, and 20 shown below, the result was considered to be below the reliably countable threshold, and so are reported as “<250 CFU/ml”. When reporting Log Reduction values, this cell count was subtracted from the control cell count, and the calculated log reduction value is reported as “greater than the reported value.”

In the examples described below, the values above 3 Log Reduction meet the EPA performance standard. The values found to be less than that threshold are consistent with that standard when they are either at LOD or LOQ, and so are also reported as “greater than the reported result.” The addition of LOD or LOQ on a test result allows that the value is to be understood in the context of the experimental method, where the method (that is, dilutions) did not quantify (1) any (LOD) or (2) statistically significant (LOQ) colonies. The results marked as LOD or LOQ in the inventive examples described below indicate that there were very low cell counts on all plate samples at all dilutions and thus exhibited significant antimicrobial efficacy.

The specifics for each microbiology testing protocol used in the Inventive and Comparative Examples are now described. Dilutions of inoculum were prepared, measured on a calorimeter, and then serially diluted for enumeration on plates (or carriers). Inoculum was applied to both negative controls and test carriers. After an exposure of 2 hours at the noted controlled conditions of humidity and temperature, the tested microorganisms were recovered from the test carriers and plated to enumerate living cells. The results are reported as log reduction from the negative control. Test carriers were provided as made, after chemical exposure and physical abrasion.

For the testing used on the inventive examples described below, the EPA protocols were modified slightly, keeping with the spirit of the defined protocols for the test. Thus, for some examples, the EPA abrasion protocols as written and identified for the public were followed with the modifications shown in the following TABLE I under the column identified as “Implementation of Abrasion Protocols A and C”:

TABLE I

| | Implementation of | | |
|---|---|---|---|
| Deviation from EPA | Abrasion Protocols | Abrasion | Abrasion |
| Protocol | A and C | Protocol C | Protocol A |
| Drying | 2 (with Varitemp ® | 30-60 | (5 after Dry, 10 |
| Time (min) | Heat gun - no heat | | after Wet) |
| | setting) | | |
| Abrader | BGD 526 Wet | Gardco D10V | Gardco D10V |
| Type | Abrasion Scrub | (or Equivalent) | (or Equivalent) |
| | Tester | | |
| Sponge Size | 3.6 × 8.8 | 8 × 10 | 8 × 10 |
| (cm) | | | |
| Boat Weight | 195.7 | 454.0 | 454.0 |
| (grams) | | | |
| Pressure on | 6.2 | 5.7 | 5.7 |
| Sample | | | |
| (gram/cm²) | | | |
| Grid Size for | 2 × 4 | N/A - Soak Sponge in 20 | 3 × 5 |
| Liquid Drops | | ml of Solution for 10 | |
| (cm) | | minutes | |
| Volume | 8 | | 15 |
| Liquid (ml) - | | | |
| (1 ml/drop) | | | |
| Sterile | No | Yes | Yes |
| Sponges? | | | |
| (Yes/No) | | | |

Solutions used in the tests were:
Solution A: Reagent grade sodium hypochlorite (NaOCl) at 2000+/−100 ppm.
Solution C: EPA-registered hospital disinfectant with quaternary ammonia.
Solution D: Dry (Sponge not wetted with any disinfectant)

TABLE II
Microbiology Testing Protocol A: Test Method for Evaluating
the Efficacy of Antimicrobial Surface Coatings

| Lab ID | iUVO Bioscience- Clinical Research Organization (CRO) Services |
|---|---|
| | (Rush, New York) |
| Protocol: | US EPA Test Method for Evaluating the Efficacy of Antimicrobial |
| | Surface Coatings MB-40-00 |
| Test Organisms: | |
| | Pseudomonas aeruginosa 15442 (Gram-negative bacterium) |
| | Staphylococcus aureus 6538 (Gram-positive bacterium) |
| Inoculum Volume (μl): | 20 |
| Exposure Times: (hours) | 2 |
| Organic Soil Load: | Bovine Serum Albumin, Yeast, Mucin per protocol concentrations |
| Neutralizer: | |
| Bacterial | Dey/Engley (D/E) Broth (20 ml) |
| Media: | |
| Bacterial | HIMEDIA, Synthetic Broth, AOA_{c}, #M334-500G with 10% (w/v) |
| | dextrose solution |
| Temperature and Humidity: | 25-28° C., 30-41% RH |
| Replicates: | Triplicate |
| Carrier Dimensions: | 1 inch × 1 inch (2.54 cm × 2.54 cm) |
| Carrier Sanitation method: | 70% isopropyl alcohol |
| Incubation Time: | |
| Bacterial (hours) | 24 +/− 2 |
| Target CFU/ml | |
| Bacterial (after Soil Load) | >10⁶ |
| Harvesting: | |
| Bacterial | Bacterial carriers were placed into 50 ml conical tubes containing 20 ml |
| | of Dey/Engley (D/E) Neutralizing Broth. The tubes were vortexed for |
| | 30 seconds and sonicated for 5 minutes to release bacteria from the |
| | carrier surface. |
| Enumeration: | |
| Bacterial | |
| Method | Filter Plate |
| Plate Incubation Time (hours) | 72 +/− 4 |
| Plate Incubation Temperature (° C.) | 36 +/− 1 |

TABLE III
Microbiology Test Protocol B

| | |
|---|---|
| Lab ID | University of Arizona Water & Energy Sustainable Technology Center |
| Protocol: | R&D Protocol |
| Test Organisms: | 1) Pseudomonas aeruginosa 15442 (Gram-negative bacterium) |
| | 2) Staphylococcus aureus 6538 (Gram-positive bacterium) |
| | 3) Human coronavirus 229E (Enveloped virus) |
| Inoculum Volume (μl): | 20 |
| Exposure Times (hours): | 2 |
| Organic Soil Load: | 5% Fetal Bovine Serum (FBS) |
| Neutralizer: | |
| Bacterial | Dey/Engley (D/E) Broth (5 ml) |
| Viral | 0.1% (w/v) Na thioglycolate + 0.146% (w/v) Na thiosulfate solution, (1 |
| | ml), followed by Sephadex ™ G-10 gel filtration |
| Media: | |
| Bacterial | Tryptic Soy Agar (TSA) |
| Viral | 2% FBS Minimum Essential Medium (MEM) |
| Viral Assay Host Cell Line: | MRC-5 Human Lung Fibroblast Cells (ATCC ® CCL-171) |
| Temperature and Humidity: | 21-22° C., 30-40% RH |
| Replicates: | Duplicate |
| Carrier Dimensions: | 1 inch × 1 inch (2.54 cm × 2.54 cm) |
| Carrier Sanitation method: | 95% ethanol |
| Incubation Time: | |
| Bacterial | 22 +/− 2 hours |
| Viral | Human coronavirus 229E stocks (7-log10 per ml) removed from storage |
| | at −80° C. for use on the day of the study |
| Target CFU/ml: | |
| Bacterial | >10⁵ |
| Viral | >10⁷ |
| Harvesting: | |
| Bacterial | Bacterial carriers were placed into 50 ml conical tubes containing 5 ml of |
| | Dey/Engley (D/E) Neutralizing Broth. The tubes were vortexed at high |
| | speed five times and for durations of five |
| | seconds each to release attached bacteria. Stainless steel control surfaces |
| | were also scraped using a sterile cell scraper to further facilitate removal. |
| Viral | Viral carriers were placed into 50 ml conical tubes, and rinsed 3-4 times |
| | with 1 ml of neutralizing solution [0.1% (w/v) Na thioglycolate + 0.146% |
| | (w/v) Na thiosulfate] with cell |
| | scraping, followed by transfer of the suspension to a Sephadex ™ G-10 |
| | gel filtration column. |
| Enumeration: | |
| Bacterial | |
| Method | Spread Plate |
| Plate Incubation Time | 22 +/− 2 hours |
| Viral | |
| Filtrate Dilution media | 0.9 ml of 0% FBS MEM |
| Assay method | Tissue Culture Infectious Dose at the 50% Endpoint (TCID50) |
| Assay tray Incubation | 7 days at 35° C. in a humidified 5% CO₂ atmosphere and then scored for |
| | the presence/absence of viral cytopathology (CPE) and cell toxicity |
| TCID50 Calculation | Spearman-Karber |

TABLE IV
Microbiology Testing Protocol C

| Lab ID | iUVO Bioscience Clinical Research Organization (CRO) Services (Rush, |
|---|---|
| | New York) |
| Protocol: | US EPA Interim Protocol for the Evaluation of Antimicrobial Surface |
| | Coatings |
| Test Organisms: | |
| | Staphylococcus aureus 6538 (Gram-positive bacterium) |
| Inoculum Volume (μl): | 20 |
| Exposure Times (hours): | 2 |
| Organic Soil Load: | Bovine Serum Albumin, Yeast, Mucin per protocol concentrations |
| Neutralizer: | |
| Bacterial | Dey/Engley (D/E) Broth (20 ml) |
| Media: | |
| Bacterial | Tryptic Soy Agar (TSA) |
| Temperature and Humidity: | 25-28° C., 30-40% RH |
| Replicates: | Duplicate |
| Carrier Dimensions: | 1 inch × 1 inch (2.54 cm × 2.54 cm) |
| Carrier Sanitation method: | 70% isopropyl alcohol |
| Incubation Time: | |
| Bacterial (hours) | 18-24 |
| Target CFU/ml: | |
| Bacterial (after Soil Load) | >10⁶ |
| Harvesting: | |
| Bacterial | Bacterial carriers were placed into 150 ml glass flasks containing 20 ml of |
| | Dey/Engley (D/E) Neutralizing Broth. The tubes were vortexed for 30 |
| | seconds and sonicated for 5 minutes to release bacteria from the carrier |
| | surface. |
| Enumeration: | |
| Bacterial | |
| Method | Filter Plate |
| Plate Incubation Time (hours) | 41 |
| Plate Incubation Temperature (° C.) | 36 +/− 1 |

TABLE V
Microbiology Testing Protocol D

| Lab ID | iUVO Bioscience Clinical Research Organization (CRO) Services (Rush, |
|---|---|
| | New York) |
| Protocol: | US EPA Test Method for Evaluating the Efficacy of Antimicrobial |
| | Surface Coatings MB-40-00 |
| Test Organisms: | |
| | Staphylococcus aureus 6538 (Gram-positive bacterium) |
| Inoculum Volume (μl): | 20 |
| Exposure Times (hours): | 2 |
| Organic Soil Load: | Bovine Serum Albumin, Yeast, Mucin per protocol concentrations |
| Neutralizer: | |
| Bacterial | Dey/Engley (D/E) Broth (20 ml) |
| Media: | |
| Bacterial | Tryptic Soy Agar (TSA) |
| Temperature and Humidity: | 25-28° C., 30-40% RH |
| Replicates: | Duplicate |
| Carrier Dimensions: | 1 inch × 1 inch (2.54 cm × 2.54 cm) |
| Carrier Sanitation Method: | 70% isopropyl alcohol |
| Incubation Time: | |
| Bacterial (hours) | 18-24 |
| Target CFU/ml: | |
| Bacterial (after Soil Load) | >10⁶ |
| Harvesting: | |
| Bacterial | Bacterial carriers were placed into 50 ml conical tubes containing 20 ml |
| | of Dey/Engley (D/E) Neutralizing Broth. The tubes were vortexed for 30 |
| | seconds and sonicated for 5 minutes to release bacteria from the carrier |
| | surface. |
| Enumeration: | |
| Bacterial | |
| Method | Filter Plate |
| Plate Incubation Time (hours) | 72 |
| Plate Incubation Temperature (° C.) | 36 +/− 1 |

Antimicrobial article samples, as described in the examples below, were subjected to one or more of the described microbiology testing protocols. The tested organisms were:
Tested microorganism “PA”: Pseudomonas aeruginosa 15442 (Gram-negative bacterium);
Tested microorganism “SA”: Staphylococcus aureus 6538 (Gram-positive bacterium); and
Tested microorganism “HC229E”: Human coronavirus 229E (Enveloped virus).

The copper metal patterns in various antimicrobial articles were not abraded in the working examples described below unless specifically noted.

### Inventive Example 1

INK A described above was printed as a catalytic ink onto a single opposing side of a non-porous and non-electrically conductive PET [poly(ethylene terephthalate)] film substrate [Melinex® ST505, DuPont Teijin Films] using the described patterned flexographic printing member, and imaged with a 10% screen pattern of dots, using a benchtop test printer, “IGT F1 Printability Tester” (IGT Testing Systems Inc., Arlington Heights, Ill.) using flexography. An Anilox roller system that was used to apply INK A to the flexographic printing member had values of 1.3 BCMI and 1803 lpi (4580 lines/cm), as specified by IGT Testing Systems. The printed INK A patterns were made at ambient temperature using an Anilox force of 20 Newtons (20 kgₘ/sec²), a print force of 10 Newtons (10 kgₘ/sec²), and a print speed of 0.20 m/sec. Immediately after printing the catalytic ink, it was dried and cured with a UV Fusion system at a setting equivalent to ˜300 mJ/cm² (UV-A). The printed pattern comprised half-tone dots with average diameters of 63-64 μm and an average distance between half-tone dots of 145 μm.

The result of these operations was an intermediate article comprising printed catalyst ink patterns on the first opposing side of the PET substrate. This intermediate article was available for immediate further operation or for later further operation.

The intermediate article was then subjected to electroless copper plating by immersing it for 30 minutes at 35° C. in a 1 liter bath of a commercially available electroless copper plating solution containing Enplate® Cu-406 electroless plating solution containing copper salts (commercially available from MacDermid Enthone) to form a copper pattern on the INK A pattern, followed by rinsing it with distilled water and drying with nitrogen, to form an Inventive antimicrobial article having copper metal patterns disposed in registration, and totally covering all surfaces of the INK A patterns, similar to the pattern of unconnected halftone dots shown in FIG. 2, that were disposed on the non-electrically conductive, non-porous PET substrate.

The resulting inventive antimicrobial article had a light transmittance of 76.6% (including the PET substrate). The measured amount of copper metal, as determined by copper X-ray fluorescence (XRF) was 124 μg/cm². The measured resistance of the antimicrobial article was used to calculate a corresponding sheet resistance of in excess of 1,000,000 ohms/□, indicating that the antimicrobial article was non-electrically conductive according to the present invention.

Samples of this antimicrobial article were subjected to Microbiology testing protocol A. The SA microorganism was tested for an exposure time of 2 hours. Duplicate testing results showed a Log Reduction from the corresponding negative control of 2.39 and 1.55, corresponding to 99.6% and 97.1% reductions, respectively. The PA microorganism was similarly tested and the results showed a Log Reduction from the negative control of 2.58, corresponding to a 99.74% reduction in the PA microorganism.

These results demonstrate that non-electrically conductive, antimicrobial articles of the present invention (comprising unconnected copper metal features registered on unconnected INK A features) having a light transmission greater than 60%, exhibited significant antimicrobial effects against both a typical Gram-positive bacterium and a typical Gram-negative bacterium.

### Inventive Example 2

INK A described above was printed onto a single opposing surface of a non-electrically conductive, non-porous PET [poly(ethylene terephthalate)] film substrate [Melinex® ST505, DuPont Teijin Films] using the described flexographic printing member, imaged with a 15% screen pattern of INK A dots, using a benchtop test printer, “IGT F1 Printability Tester” (IGT Testing Systems Inc., Arlington Heights, Ill.), in the flexographic mode. The Anilox roller system that was used to apply INK A to the flexographic printing member had values of 1.3 BCMI and 1803 lpi (4580 lines per cm), as specified by IGT Testing Systems. The printed patterns were made at ambient temperature using an Anilox force of 20 Newtons (20 kgₘ/sec²), a print force of 10 Newtons (10 kgₘ/sec²), and a print speed of 0.20 m/sec. Immediately after printing INK A, it was dried and cured using a UV Fusion system at a setting equivalent to ˜300 mJ/cm² (UV-A). The printed INK A pattern comprised halftone dots with average diameters of 64-65 μm and an average distance between dots of 115 μm.

The result of these operations was an intermediate article comprising printed patterns of INK A halftone dots on the single opposing surface of the PET film substrate. This intermediate article was available for immediate further operation or for later further operation.

The intermediate article was subjected to electroless copper plating by immersing it for 30 minutes at 35° C. in a 1 liter bath of a commercially available electroless copper plating solution in a beaker containing a cm Enplate® Cu-406 electroless plating solution containing copper salts (commercially available from MacDermid Enthone) to form a copper pattern on the INK A pattern of halftone dots, followed by rinsing with distilled water and drying with nitrogen, to form an inventive antimicrobial article with copper patterns disposed in registration, and totally covering all surfaces of the INK A patterns, similar to the pattern of unconnected halftone does shown in FIG. 2.

The resulting antimicrobial article exhibited a light transmittance of 67.3% (including the PET film substrate). The measured amount of copper metal, as determined by copper X-ray fluorescence (XRF) was 175 μg/cm². The antimicrobial article was non-electrically conductive as the measured resistance using a 4-point probe corresponded to a sheet resistance of greater than 1,000,000 ohm/□, indicating that the antimicrobial article was non-electrically conductive according to the present invention.

Samples of this antimicrobial article were subjected to Microbiology testing protocol A as described above. The presence of microorganism SA was tested after an exposure time of 2 hours. Duplicate testing results show a Log Reduction from the corresponding negative control of 2.09 and 2.45, corresponding to 99.2% and 99.64% reductions, respectively. Microorganism PA was also tested after an exposure time of 2 hours. The results showed a Log Reduction from the negative control of greater than 4.23 (LOQ), corresponding to a greater than 99.99% reduction.

These results demonstrate that non-electrically conductive antimicrobial articles of the present invention (comprising unconnected copper metal features registered on unconnected INK A features) having light transmission greater than 60%, exhibited significant antimicrobial effects against both typical Gram-positive bacterium and typical Gram-negative bacterium.

### Inventive Example 3

INK A described above was printed onto both opposing surfaces of a non-porous non-electrically conductive PET [poly(ethylene terephthalate)] film substrate [Melinex® ST505, DuPont Teijin Films] using a patterned flexographic printing member and a Mark-Andy, roll-to-roll, multi-station press at 20 ft/min (6.06 m/min) such as that described in U.S. Pat. No. 10,334,739B2 (Honan et al.), the disclosure of which is incorporated herein by reference. The patterned flexographic printing member was imaged with a series of intersecting lines of INK A. A UV curing lamp was placed immediately following each printing station to cure the printed pattern of INK A. The resulting intermediate article of printed and cured INK A patterns on the continuous web substrate was taken up in a roll form.

This intermediate article roll was unrolled, fed by web advance system along a web-transport path in an in-track direction from a supply roll, and submersed in a bath of a commercially available electroless copper plating solution using a roll-to-roll electroless plating system containing Enplate® CU406 electroless plating solution containing copper salts (commercially available from MacDermid Enthone), to form a pattern of copper on the INK A pattern, followed by an additional step of submersing the roll into a commercial solution of ENTEK® Antitarnish Cu-56, an anti-tarnish agent and a corrosion inhibitor, followed by rinsing with distilled water and drying with nitrogen, to form the inventive antimicrobial article having multiple copper patterns disposed in registration on the patterns of catalytic ink on the PET substrate, as disclosed in US. Patent Application Publication 2016/0168713 (Reuter et al.) and described in U.S. Pat. No. 10,334,739B2 (noted above). The electroless plating system included a tank of copper plating solution. The web of inventive antimicrobial articles was then taken up in a take-up roll that could be later cut into suitable pieces for use.

The resulting antimicrobial article was comprised of multiple copper patterns each having intersecting lines of average line widths of 13 μm and an average pitch of 77-78 μm (corresponding to spacings of 63 μm), similar to the micro-pattern shown in FIG. 1. The measured amount of copper, as determined by copper X-ray fluorescence (XRF) was 267 μg/cm².

Samples of this antimicrobial article were subjected to several Microbiology testing protocols using several microorganisms, as described above. The results are listed below in TABLE VI.

TABLE VI
Results Obtained with the Antimicrobial Article of Inventive Example 3

| Microbiology | Abraded? | | Exposure | | | Quality |
|---|---|---|---|---|---|---|
| Testing | (No/Yes), | Micro- | Time | Log | % | Status (OK, |
| Protocol | Solution? | organism | (hours) | Reduction | Reduction | LOD, LOQ) |
| A | No | SA | 2 | 2.61 | 99.75 | LOQ |
| A | No | SA | 2 | 2.66 | 99.78 | LOQ |
| A | No | PA | 2 | 3.79 | 99.98 | OK |
| B | No | SA | 1 | 4.73 | 99.998 | LOD |
| B | No | SA | 2 | 4.93 | 99.998 | LOD |
| B | No | PA | 1 | 4.63 | 99.998 | LOD |
| B | No | PA | 2 | 4.6 | 99.997 | LOD |
| B | No | HC229E | 1 | 2.75 | 99.8 | LOD |
| B | No | HC229E | 2 | 2.75 | 99.8 | LOD |
| C | Yes, A | SA | 2 | 2.53 | 99.7 | LOQ |
| D | No | SA | 2 | 3.15 | 99.9 | OK |

These results demonstrate that antimicrobial articles prepared in a continuous web or roll form exhibited significant antimicrobial effects against Gram-positive bacterium, Gram-negative bacterium, and against an Enveloped virus, even after the copper plated patterns had been abraded and/or treated with an anti-tarnish and anti-corrosion inhibitor.

### Inventive Example 4

INK A was printed onto both opposing surfaces of a non-electrically conductive, non-porous PET [poly(ethylene terephthalate)] film substrate [Melinex® ST505, DuPont Teijin Films] using a patterned flexographic printing member and Mark-Andy, roll-to-roll, multi-station press at 20 ft/min (6.06 m/min), such as that described in U.S. Pat. No. 10,334,739B2 (noted above). The patterned flexographic printing member used for printing was imaged with a series of intersecting lines. A UV curing lamp was situated immediately following each printing station. The resulting intermediate article with printed INK A patterns was taken up in roll form.

As described above for Inventive Example 3, copper electroless plating of the INK A patterns on the intermediate article was carried out using a commercially available electroless copper plating chemistry to form a pattern of copper on the INK A patterns, followed by rinsing with distilled water and drying with nitrogen, and using a take up roll to provide a suitable roll of antimicrobial articles that could be cut into individual pieces for suitable uses.

The resulting antimicrobial article comprised multiple copper metal patterns, each comprising intersecting lines of average line widths of 11-18 μm and an average pitch of 125 μm. The measured amount of copper, as determined by copper X-ray fluorescence (XRF) was 111 μg/cm².

Samples of this antimicrobial article were subjected to several Microbiology testing protocols, using several microorganisms that are described above. The results are listed in TABLE VII below.

TABLE VII
Results Obtained with the Antimicrobial Article of Inventive Example 4

| Microbiology | Abraded? | | Exposure | | | Quality |
|---|---|---|---|---|---|---|
| testing | (No, Yes) | Micro- | time | Log | % | Status (OK, |
| protocol | Solution? | organism | (hours) | Reduction | Reduction | LOD, LOQ) |
| A | No | SA | 2 | 2.61 | 99.75 | LOQ |
| A | No | SA | 2 | 2.66 | 99.78 | LOQ |
| A | No | PA | 2 | 4.23 | 99.99 | LOQ |
| D | No | SA | 2 | 3.16 | 99.9 | LOQ |

These results demonstrate that antimicrobial articles containing electrolessly copper plated patterns, where the effective surface of each pattern is pure copper metal, exhibit significant antimicrobial effects against both Gram-positive bacterium and Gram-negative bacterium, regardless of the electroless plating chemistry. These results also show that intermediate articles can be prepared in roll form that can then be treated, when desired, with an electroless plating operation, followed by cutting into desired sections or pieces of antimicrobial articles.

### Inventive Example 5

INK A was printed onto both sides of a non-electrically conductive, non-porous PET [poly(ethylene terephthalate)] film substrate [Melinex® ST505, DuPont Teijin Films] using a patterned flexographic printing member and a Mark-Andy, roll-to-roll, multi-station press at 20 ft/min (6.06 m/min), such as that described in U.S. Pat. No. 10,334,739B2 (noted above). The patterned flexographic printing member was imaged with a series of intersecting lines having average line widths of 9-13 μm and an average pitch of 77-80 μm. Immediately following each printing station, the patterns of INK A were cured using a UV lamp, and were taken up in a roll form as an intermediate article.

Later, individual sheets from this intermediate article were subjected to electroless copper plating by immersing each for 30 minutes at 35° C. in a 1 liter bath in a beaker containing a commercially available electroless copper plating solution Enplate® Cu-406 electroless plating solution containing copper salts (commercially available from MacDermid Enthone), followed by rinsing with distilled water and drying with nitrogen, to form the inventive antimicrobial article with copper patterns disposed in registration on INK A pattern disposed on the PET substrate. The measured amount of copper, as determined by copper X-ray fluorescence (XRF) was 134 μg/cm².

Samples of this antimicrobial article were subjected to several Microbiology testing protocols using several microorganisms, as described above. The results are listed in TABLE VIII below.

TABLE VIII
Results Obtained with the Antimicrobial Article of Inventive Example 5

| Microbiology | Abraded? | | Exposure | | | Quality |
|---|---|---|---|---|---|---|
| testing | (No/Yes) | Micro- | time | Log | Percent | Status (OK, |
| protocol | Solution? | organism | (hours) | Reduction | Reduction | LOD, LOQ) |
| B | No | SA | 1 | 4.73 | 100 | LOD |
| B | No | SA | 2 | 4.1 | 100 | LOD |
| B | No | PA | 1 | 4.63 | 100 | LOD |
| B | No | PA | 2 | 4.6 | 100 | LOD |
| B | No | HC229E | 1 | 2.75 | 99.8 | LOD |
| B | No | HC229E | 2 | 2.75 | 99.8 | LOD |
| D | No | SA | 2 | 3.16 | 99.9 | LOQ |

These results demonstrate that the antimicrobial articles of the present invention having copper metal patterns exposed to microorganisms, exhibit significant antimicrobial effects against both Gram-positive bacterium and Gram-negative bacterium, and against an Enveloped virus, regardless of the electroless plating method.

### Inventive Example 6

INK A was printed onto both sides of a non-electrically conductive, non-porous PET [poly(ethylene terephthalate)] film substrate [Melinex® ST505, DuPont Teijin Films] using a patterned flexographic printing member and a Mark-Andy, roll-to-roll, multi-station press at 20 ft/min (6.06 m/min) such as that described in U.S. Pat. No. 10,334,739B2 (noted above). The patterned flexographic printing member was imaged with a series of intersecting lines having average line widths of 9-13 μm and an average pitch of 77-80 μm. Immediately following each printing station, each pattern of INK A was cured using a UV lamp, and taken up in a roll form to provide an intermediate article for further operation.

Later, individual cut sheets from this intermediate article were subjected to electroless copper plating by immersing each sheet for 30 minutes at 35° C. in a 1 liter bath in a beaker containing a commercially available electroless copper plating solution Enplate® Cu-406 electroless plating solution containing copper salts (commercially available from MacDermid Enthone) to form copper patterns in registration on the INK A patterns, followed by rinsing with distilled water. Following these operations, a darkening agent was applied directly to the copper patterns by immersing each pattern in a beaker containing an aqueous solution of palladium sulfate (supplied by Atotech) at 29° C. for 3 minutes to deposit a dark palladium layer. Further details of this operation are described also in U.S. Ser. No. 18/359,097, filed Jul. 26, 2023 by Farmer et al., the disclosure of which is incorporated herein by reference.

This was followed by rinsing with distilled water and drying with nitrogen to form the antimicrobial article of the present invention having antimicrobial copper metal patterns that had been blackened and treated against tarnishing. The measured amount of copper metal, as determined by copper X-ray fluorescence (XRF) was 124 μg/cm². The measured amount of palladium, as determined by X-ray fluorescence (XRF) was 2.99 μg/cm².

Samples of this antimicrobial article were subjected to Microbiology testing protocol B using several microorganisms, as described above. The results are listed in TABLE IX below.

TABLE IX
Results Obtained for Antimicrobial Article of Inventive Example 6

| Microbiology | Abraded? | | Exposure | | | Quality |
|---|---|---|---|---|---|---|
| testing | (No/Yes), | Micro- | time | Log | % | Status (OK, |
| protocol | Solution? | organism | (hours) | Reduction | Reduction | LOD, LOQ) |
| B | N | SA | 2 | 2.31 | 99.3 | OK |
| B | N | PA | 1 | 4.63 | 100 | LOD |
| B | N | PA | 2 | 4.6 | 100 | LOD |
| B | N | HC229E | 1 | 2.75 | 99.8 | LOD |
| B | N | HC229E | 2 | 2.75 | 99.8 | LOD |

These results demonstrate that the antimicrobial articles of the present invention exhibit significant antimicrobial effects against both Gram-positive bacterium and Gram-negative bacterium, and against an Enveloped virus, even after the copper metal patterns have been treated with a thin coating of a Palladium darkening agent.

### Inventive Examples 7-9

Samples of the antimicrobial article described in Inventive Example 4 were subjected to Microbiology testing protocol A after at least one sample was subjected to each of the abrasion protocols described in detail in US EPA MB-40-00.

TABLE X
Results Obtained with Antimicrobial Articles of Inventive Examples 7-9

| | Microbiology | Abraded? | | Exposure | | | Quality |
|---|---|---|---|---|---|---|---|
| | Testing | (No/Yes), | Micro- | time | Log | % | Status (OK, |
| Sample | Protocol | Solution | organism | (hours) | Reduction | Reduction | LOD, LOQ) |
| Inventive | A | Yes, A | SA | 2 | 2.58 | 99.74 | LOQ |
| Example 7 | | | | | | | |
| Inventive | A | Yes, C | SA | 2 | 2.58 | 99.74 | LOQ |
| Example 8 | | | | | | | |
| Inventive | A | Yes, D | SA | 2 | 2.58 | 99.74 | LOQ |
| Example 9 | | | | | | | |
| Inventive | A | Yes, A | PA | 2 | 5.63 | 100 | LOD |
| Example 7 | | | | | | | |
| Inventive | A | Yes, C | PA | 2 | 4.23 | 99.99 | LOQ |
| Example 8 | | | | | | | |
| Inventive | A | Yes, D | PA | 2 | 3.54 | 99.97 | OK |
| Example 9 | | | | | | | |

The results shown in TABLE X demonstrate that antimicrobial articles of the present invention comprising electrolessly copper metal plated patterns disposed in registration with catalytic ink patterns exhibited significant antimicrobial effects against both a Gram-positive and Gram negative bacterium even after the copper metal patterns had been abraded as noted.

### Comparative Example 1

A sample of non-electrically conductive, non-porous PET [poly(ethylene terephthalate)] film substrate [Melinex® ST505, DuPont Teijin Films] was evaluated for antimicrobial effectivity. This PET substrate was identical to that used for all the Inventive examples described above. No catalytic ink pattern and copper metal pattern were provided on this PET substrate sample. However, the PET substrate sample was subjected to Microbiology testing protocol B using several microorganisms, as described above. The results are shown in TABLE XI below.

TABLE XI
Results Obtained with Substrate Only

| Microbiology | | Exposure | | |
|---|---|---|---|---|
| Testing | | time | Log | % |
| Protocol | Microorganism | (hours) | Reduction | Reduction |
| B | SA | 1 | −0.06 | −4 |
| B | SA | 2 | −0.27 | −65 |
| B | PA | 1 | 0.35 | 55 |
| B | PA | 2 | 0.38 | 59 |
| B | HC229E | 1 | 0.17 | 22 |
| B | HC229E | 2 | 0.17 | 32 |

These results demonstrate that the non-electrically conductive, non-porous PET substrate alone did not exhibit antimicrobial effects against either Gram-positive bacterium or Gram-negative bacterium, or against an Enveloped virus. All reported percent reduction values are within 1 log unit, which demonstrates insignificant efficacy as expected. Negative values indicate microorganism growth.

### Comparative Example 2

The intermediate article prepared in Inventive Example 3 was tested without any electroless copper plating being carried out. Thus, the intermediate article was tested without copper metal patterns.

The intermediate article comprised an INK A pattern containing silver nanoparticles in the form of intersecting lines of average line widths of 9-13 μm and an average pitch of 77-80 μm. Since no copper metal was applied, the measured amount of copper metal, as determined by copper X-ray fluorescence (XRF) was 0 ug/cm².

This intermediate article was then subjected to Microbiology testing protocol B using several microorganisms that are described above. The test results are listed in TABLE XII below.

TABLE XII
Results Obtained for Intermediate Article

| Microbiology | | Exposure | | |
|---|---|---|---|---|
| Testing | | time | Log | % |
| Protocol | Microorganism | (hours) | Reduction | Reduction |
| B | SA | 1 | 0.27 | 46 |
| B | SA | 2 | −0.06 | −35 |
| B | PA | 1 | −0.33 | −112 |
| B | PA | 2 | −0.06 | −35 |
| B | HC229E | 1 | 0.5 | 69 |
| B | HC229E | 2 | 0.13 | 11 |

These results demonstrate that this intermediate article having a pattern of a catalytic ink only on the non-electrically conductive, non-porous PET substrate (but with no copper metal pattern) did not exhibit significant antimicrobial effects against either Gram-positive bacterium or Gram-negative bacterium, or against an Enveloped virus. All values shown in TABLE XII are within 1 log unit, which demonstrates insignificant efficacy. Negative values indicate microorganism growth.

The invention has been described in detail with particular reference to certain preferred embodiments thereof, but it will be understood that variations and modifications can be effected within the spirit and scope of the invention.

### PARTS LIST

10 Antimicrobial article
12 Non-electrically conductive substrate
14 First opposing surface
16 Second opposing surface
18 Composite features
20 Catalytic ink features
22 Copper metal features

1. An intermediate article comprising:
a non-electrically conductive substrate comprising first and second opposing surfaces; and
a catalytic ink disposed as a pattern of half-tone dots on at least the first opposing surface.

2. The intermediate article of claim 1 that is in roll form.

3. The intermediate article of claim 2 in roll form that further comprises a liner sheet between the second opposing surface of the non-electrically conductive substrate and the catalytic ink pattern of half-tone dots.

4. The intermediate article of claim 1, wherein the catalytic ink comprises an organic polymer and silver nanoparticles.

5. The intermediate article of claim 1, having a light transmittance of at least 60%.

6. The intermediate article of claim 1, having a light transmittance of at least 75%.

7. The intermediate article of claim 1, wherein the non-electrically conductive substrate is a flexible film and comprises one or more organic polymers.

8. The intermediate article of claim 1, wherein the non-electrically conductive substrate comprises poly(ethylene terephthalate).

9. The intermediate article of claim 1, wherein the non-electrically conductive substrate comprises a nonadherent film or fine mesh gauze.

10. The intermediate article of claim 1, wherein the non-electrically conductive substrate comprises a fabric.

11. The intermediate article of claim 1, wherein the non-electrically conductive substrate comprises a cellulosic material or a flexible glass.
